(19) United States
(12) Patent Application Publication
(10) Pub. No.: US 2013/0084210 A1
(43) Pub. Date: Apr. 4, 2013

(54) SURFACTANTLESS METALLIC NANOSTRUCTURES AND METHOD FOR SYNTHESIZING SAME

(71) Applicant: The Research Foundation of State University of, Albany, NY (US)

(72) Inventors: Stanislaus S. WONG, Stony Brook, NY (US); Christopher Koenigsmann, Mahopac, NY (US)

(73) Assignee: The Research Foundation of State University of New York, Albany, NY (US)

(21) Appl. No.: 13/632,656

(22) Filed: Oct. 1, 2012

Related U.S. Application Data
(60) Provisional application No. 61/541,751, filed on Sep. 30, 2011.

(51) Int. Cl. B22F 9/24; B82Y 40/00; B82Y 30/00

(52) U.S. Cl. 420/591; 75/370; 977/762; 977/896

(57) ABSTRACT

Disclosed are nanowires and a nanowire synthesis method, with the nanowires synthesized by adding first and second solutions into a vessel containing a porous template, the first solution added on one side of the porous template and the second solution added on another side of the porous template. The first solution contains a metal reagent comprising at least one of a transition metal, an actinide and a lanthanide metal, and the second solution contains a reducing agent.

### PRIORITY

This application claims priority to U.S. Provisional Application No. 61/541,751, filed with the U.S. Patent and Trademark Office on Sep. 30, 2011, the entire content of which is incorporated herein by reference.

### BACKGROUND OF THE INVENTION

1. Field of the Invention

The present invention relates generally to nanotechnology and, more particularly, to a method for synthesizing metallic nanostructures.

2. Description of the Related Art

One-dimensional (1-D) metallic nanostructures provide unique structure-dependent optical, electrical, and thermal properties. In addition, metallic nanostructures are effective electrocatalysts for Oxygen Reduction Reactions (ORR) and alcohol electro-oxidation reactions in Polymer Electrolyte Membrane Fuel Cells (PEMFCs). Conventional PEMFCs, such as nanoparticulate platinum based catalysts, suffer from low efficiencies as well as high cost. Low efficiency of PEMFCs arises from slow oxygen reduction kinetics, resulting in cathodic overpotential. Platinum nanoparticle catalysts possess a relatively high number of defect sites and low-coordination atoms at their surface as a result of a zero-dimensional (O-D) structure, which renders the platinum nanoparticles less active toward ORR and necessitates high loadings in a range of 0.15 to 0.25 mg/cm² to achieve practical efficiencies.

Koenigsmann et al. in Size-Dependent Enhancement of Electrocatalytic Performance in Relatively Defect-Free, Processed Ultrathin Platinum Nanowires Nano. Lett. 2010, 10, 2806-2811, investigate size dependence of 1-D platinum nanostructures on activity, comparing relevant activity of nanotubes with diameters of 200 nm to that of 1 nm diameter platinum nanowires. Electrochemically determined specific activities for ORR indicate a nearly 4-fold increase in specific activity from 0.38 to 1.45 mA/cm² as the 1-D platinum nanostructure diameter decreases from 200 nm to 1.3 nm. This size-dependent increase in activity of 1-D nanostructures, as the diameter decreases from the submicrometer range, i.e., 100 nm<diameter<1 μm, to the nanometer range, i.e. diameter<100 nm, contrasts with that of 0-D carbon supported platinum nanoparticles. In 0-D carbon supported platinum nanoparticle catalysts, activity decreases significantly as particle size decreases from the submicrometer to nanometer sizes, particularly when particle size decreases below 5 nm. Nanometer-sized platinum 1-D catalysts activity is observed to arise from contraction of the platinum nanostructure surface. The small diameter of the nanometer platinum nanowire catalysts minimizes precious metal wasted in the core of the nanowire, while also providing increased electrochemical activity.

Nevertheless, a continuing challenge in exploration of size-dependent trends with 1-D nanostructures is the development of environmentally friendly methods for synthesis of crystalline, high purity nanostructures with high aspect ratios and predictable dimensions. Many solution-based methods for preparing 1-D noble metal nanowires have been reviewed by Tiano et al., in Solution-Based Synthetic Strategies for One-Dimensional Metal-Containing Nanostructures, Chem. Comm. 2010, 46, 8093-8130. For example, Xia et al., in Shape-Controlled Synthesis of Metal Nanostructures: The Case of Palladium Adv. Mater. 2007, 19, 3385-3391, provide methods utilizing elevated temperatures and pressures for preparation of anisotropic nanostructures of palladium such as nanorods, nanoplates, nanocubes, and twinned nanoparticles, where control of reaction kinetics with additives, such as inorganic salts and surfactants, yield nanostructures with predictable morphology. Zheng et al., in One-Pot, High-Yield Synthesis of 5-Fold Twinned Pd Nanowires and Nanorods, J. Am. Chem. Soc. 2009, 131, 4602-4603, demonstrate generation of high-quality palladium nanowires and nanorods with diameters of 9.0 nm at elevated temperatures, employing poly(vinylpyrrolidone) as both a surfactant and as an in situ reducing agent.

Although the methods described above generate high quality 1-D nanostructures, a limitation of these synthetic methods is a lack of control over diameter and aspect ratio of the synthesized nanostructures. In addition, surfactant molecules serving as capping agents in these synthetic methods are adsorbed onto surfaces of the nanostructures. Surfactant adsorption limits application of the nanostructures as catalysts, sensors and electrocatalysts, since decreased exposure of the surfaces of the nanostructures inhibits activity.

In light of these limitations, porous template-based methods are employed in synthesis of 1-D nanostructures. Specifically, dimensions of pores within a porous template determine size and morphology of nanostructures grown within the porous template. Regarding template-based synthesis of nanostructured metals, Wang et al., in Pd Nanowire Arrays as Electrocatalysts for Ethanol Electrooxidation Electrochem. Comm. 2007, 9, 1212-1216, provide a method for obtaining 1-D nanostructures through electro-deposition of precursors within either Polycarbonate (PC) or Anodic Alumina Oxide (AAO) porous templates. For example, arrays of palladium nanostructures with uniform diameters of 80 nm were prepared by Wang et al. through electro-deposition within an AAO template having pore sizes of 80 nm. However, the electro-deposition method described by Wang et al. requires additional electrochemical equipment, and uses caustic reaction media. Kline et al., in Template-Grown Metal Nanowires, Inorg. Chem. 2006, 45, 7555-7565, describe conventional electro-deposition methods requiring physical vapor deposition techniques to deposit a conductive metallic backing onto porous templates prior to nanostructure deposition. Collectively, these processes are costly, inefficient, and difficult to scale up.

Patete et al. in Viable Methodologies for the Synthesis of High-Quality Nanostructures, Green Chem. 2011, 13, 482-519, describe use of a U-tube double diffusion vessel as both an effective and green method for the production of high-quality 1-D metallic nanostructures under ambient conditions. U.S. Pat. No. 7,575,735 to Wong et al., which is incorporated herein by reference, utilizes a U-tube double diffusion vessel in synthesis of metal oxide and metal fluoride nanostructures. Further, U.S. Patent Publication No. 2010/0278720 A1 to Wong et al., which is incorporated herein by reference, utilizes the U-tube double diffusion vessel to synthesize metal oxide nanostructures. The U-tube methods of Patete et al. and Wong et al. provide metal oxide and metal fluoride nanowires by precipitation of a metal cation with an appropriate anion, i.e., OH⁻ or F⁻, for growth of the nanowire. However, Patete et al. and Wong et al. do not provide a method to prepare nanowires composed of metal only without other non-metal components, since two separate reagents must react to form the nanowire. Another shortcoming of Patete et al. and Wong et al. is that the metal component within the metal oxide or metal fluoride nanowire maintains a cationic state and is not fully reduced, which reduces catalytic performance of the nanowire, particularly towards ORR. Conventional methods fail to disclose formation of metallic nanowires without non-metal components under ambient, surfactantless conditions.

### SUMMARY OF THE INVENTION

The method of the present invention overcomes the above shortcomings of conventional methods and systems by providing surfactantless and electroless methods for nanowire synthesis under environmentally benign conditions, to provide a nanowire, and method for synthesis thereof, produced by adding first and second solutions to a vessel containing a porous template with the first solution added on one side of the porous template and the second solution added on another side of the porous template. The first solution contains a metal reagent including at least one of a transition metal, an actinide metal and a lanthanide metal, and the second solution contains a reducing agent.

### BRIEF DESCRIPTION OF THE DRAWINGS

The above and other aspects, features and advantages of certain embodiments of the present invention will be more apparent from the following detailed description taken in conjunction with the accompanying drawings, in which:

FIG. 1 illustrates a U-tube double diffusion vessel employed to synthesize nanowires of the present invention;

FIGS. 2-3 are porous template schematics showing steps of growth of nanowires of the present invention;

FIG. 4 is a flowchart of a nanowire synthesis method of the present invention;

FIGS. 5-6 are powder X-Ray Diffraction (XRD) graphs of palladium nanowires of the present invention;

FIGS. 7-8 are Transmission Electron Microscopy (TEM) images of a cross-section of the porous template containing palladium nanowires of the present invention;

FIGS. 9-18 are Scanning Electron Microscopy (SEM) images of palladium nanowires of the present invention;

FIGS. 19-20 are graphs showing correlation of nanowire length and aspect ratio to reagent concentration for palladium nanowires of the present invention;

FIG. 21 is a graph showing correlation of nanowire length to reaction time for palladium nanowires of the present invention;

FIGS. 22-23 are TEM images of palladium nanowires of the present invention;

FIGS. 24-25 are High Resolution TEM (HRTEM) images of a palladium nanowire of the present invention;

FIGS. 26-27 are TEM images of palladium nanowires of the present invention;

FIG. 28 is an HRTEM image of a palladium nanowire of the present invention;

FIGS. 29-30 are Selected Area Electron Diffraction (SAED) images of palladium nanowires of the present invention;

FIG. 31 is a TEM image of a palladium nanowire shown in FIG. 7;

FIG. 32 is an HRTEM image of the palladium nanowire shown in FIG. 31;

FIG. 33 is an SAED image of the palladium nanowire shown in FIG. 31;

FIG. 34 is an HRTEM image of the palladium nanowire shown in FIG. 31;

FIG. 35 is an SAED image of the palladium nanowire shown in FIG. 31;

FIG. 36 is a TEM image of the palladium nanowires shown in FIG. 8;

FIG. 37 is an HRTEM image of a palladium nanowire shown in FIG. 36;

FIGS. 38-39 are SAED images of the palladium nanowire shown in FIG. 36;

FIG. 40 is an HRTEM image of the palladium nanowire shown in FIG. 36;

FIG. 41 is an SAED image of the palladium nanowire shown in FIG. 36;

FIGS. 42-43 are cyclic voltammograms characterizing electrochemical performance of palladium nanowires of the present invention;

FIGS. 44-45 are a graph and bar chart, respectively, of electrocatalytic performance of palladium nanowires of the present invention;

FIGS. 46-48 are an SEM image, a cyclic voltammetry graph and a powder XRD graph, respectively, of ruthenium nanowires of the present invention; and

FIGS. 49-50 are TEM images of platinum and gold nanowires, respectively, of the present invention.

### DETAILED DESCRIPTION OF EMBODIMENTS OF THE PRESENT INVENTION

The following detailed description of certain embodiments of the present invention will be made in reference to the accompanying drawings. In describing the invention, explanation about related functions or constructions known in the art are omitted for the sake of clearness in understanding the concept of the invention, to avoid obscuring the invention with unnecessary detail.

A method for synthesizing a nanostructure, i.e. a nanowire, and compositions derived from such a method, is provided. Specifically, the method provides a synthesis of metallic nanowires, avoiding use of surfactants, electrochemical equipment, toxic reaction media, and physical vapor deposition techniques. Further, the method utilizes environmentally friendly solvents, such as alcohols or water, and is performed under ambient conditions. The method employs a U-tube double diffusion vessel to prepare high-quality, single crystalline, metallic nanowires. The diameter of the nanowires is reliably controlled and ranges from 1 nm to 1 μm. The nanowires are substantially free of non-metallic impurities, such oxides, halides, sulfides, phosphides, or nitrides, and organic contaminants, such as capping agents, surface ligands or surfactants without additional purification steps.

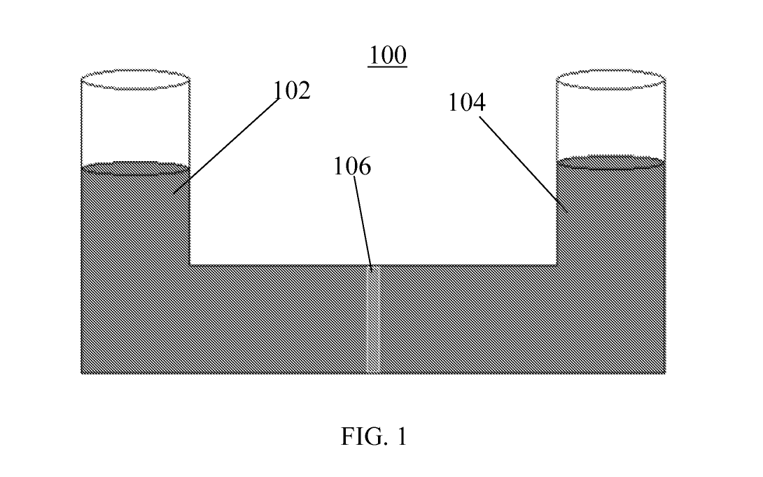

FIG. 1 illustrates a U-tube double diffusion vessel employed in synthesizing a nanowire, according to an embodiment of the present invention. Specifically, synthesis of nanowires is achieved by addition of a first solution 102 including a metal reagent, i.e. a metal precursor, such as a metal salt, and a second solution 104 including a reducing agent into first and second half-cells, respectively, of a U-tube double diffusion vessel 100. The metal reagent and the reducing agent co-diffuse into pores of a porous template 106. The pores of the porous template 106 direct nucleation, i.e. initial formation, and nanowire growth.

According to an embodiment of the present invention described herein, the method utilizes the U-tube double diffusion vessel 100 to provide control over properties of the nanowire. A diameter of the nanowire is determined by a diameter of the pores of the porous template 106. Nanowire length is controlled by one of a concentration of the metal reagent, a concentration of the reducing reagent and the reaction time. The length of the nanowire is limited by a length of the pores of the porous template 106. Elemental composition of the nanowire is determined by selection of the metal reagent added to the first solution 102.

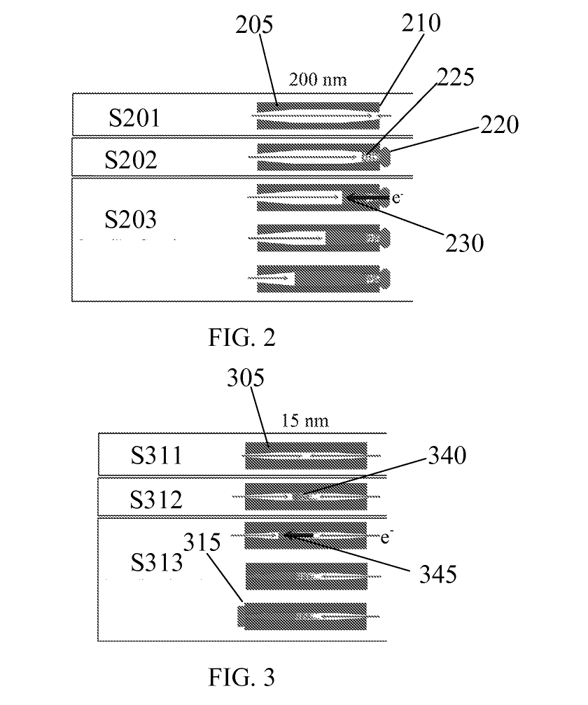

FIG. 2 is a schematic illustrating nanowire growth within a single pore, according to the present invention. As shown in FIG. 2, a porous template having 200 nm pores is provided, and steps S201-S203 illustrate a growth mechanism for nanowire synthesis within the porous template.

In step S201 of FIG. 2, the first solution, including the metal reagent, and the second solution, including the reducing agent, diffuse into pore 205 of the porous template 106, with such diffusion illustrated by the opposing arrows. In step S202, the metal reagent is reduced by the reducing agent and nucleation of a nanowire begins. For 200 nm template pores, nucleation of the nanowire occurs at an interface of the pores and the second solution on an external surface 210 of the porous template. Nucleation begins with formation of a metallic surface 220 on the external surface 210 of the porous template and followed by a polycrystalline segment 225 of the nanowire within the template pore 205 with a length of less than 1 μm. Formation of the metallic surface 220 on the external surface 210 of the porous template is observed visually within a minute of addition of the first and second solutions to the U-tube vessel. The formation of the polycrystalline segment 225 in step S202 ends when the polycrystalline segment 225 and the metallic surface 220 create a barrier between the second solution and the pore 205 and prevent diffusion of the second solution into the pore.

In step S203, a single crystalline segment 230 of the nanowire forms on, and grows from, the polycrystalline segment 225 of the nanowire within the pore 205 of the porous template through an electroless deposition process. Specifically, electrons (e) transfer through the metallic surface 220 and the polycrystalline segment 225, reducing the metal reagent inside of the template pore 205. As observed, transferred electrons, and not direct interaction with the reducing agent, reduce the metal reagent to form the single crystalline segment 230 of the nanowire, whereas the polycrystalline segment 225 is believed to form as a result of direct interaction with, and reduction by, the reducing agent. Formation of the single crystalline segment of the nanowire extends into the pore 205 of the porous template towards the first solution. Completion of the reaction in step S203 is visually observed by formation of a metallic layer on the surface of the template exposed to the first solution, which confirms that the nanowires have filled the template pore 205.

Referring to FIG. 3, a schematic of a porous template having 15 nm pores is illustrated, with steps S311-S313 illustrating a growth mechanism for nanowire synthesis within the porous template.

In step S311, the first solution, including the metal reagent, and the second solution, including the reducing agent, diffuse into pores 305 of the porous template, with such diffusion illustrated by the opposing arrows. In step S312, the metal reagent is reduced by the reducing agent and nucleation of a nanowire begins. For 15 nm template pores, nucleation of the nanowire occurs in a central region of the template pore 305 where the first and second solutions interact directly by diffusion. Nucleation of the nanowire begins with formation of a polycrystalline segment 340 of the nanowire within an interior of the pore 305 of the porous template. Formation of the polycrystalline segment 340 in step S312 ends when the polycrystalline segment 340 creates a physical barrier between the first and second solutions, and prevents diffusion of the second solution into the pore 305.

In step S313, a single crystalline segment 345 of the nanowire forms on the polycrystalline segment 340 of the nanowire within the pore 305 of the porous template through electroless deposition. Specifically, electrons (e) transfer through the polycrystalline segment 340 when a diameter of the polycrystalline segment equals a diameter of the pore 305 of the porous template. Therefore, the transferred electrons, and not direct interaction with the reducing agent, reduce the metal reagent to form the single crystalline segment 345, whereas the polycrystalline segment 340 is believed to form as a result of direct interaction with, and reduction by, the reducing agent. Formation of the single crystalline segment 345 of the nanowire extends into the pore 305 of the porous template towards the first solution. Formation of a metallic surface on an external surface 315 of the porous template within the first solution is observed visually, indicating completion of the nanowire synthesis.

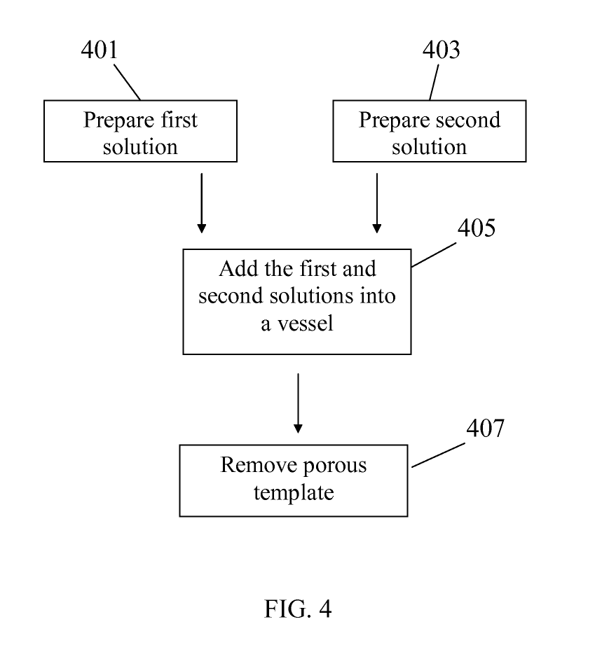

FIG. 4 is a flowchart of a nanowire synthesis method, according to an embodiment of the present invention. In steps 401 and 403, first and second solutions, respectively, are prepared. In step 405, the first and second solutions are added into a vessel, such as the U-tube double diffusion vessel of FIG. 1, containing a porous template 106. The first solution is added on one side of the porous template and the second solution added on another side of the porous template. The first solution contains a metal reagent. The metal reagent includes a metal salt of at least one of a transition metal, a lanthanide metal, and an actinide metal and mixtures thereof.

Reduction of the metal reagent may occur at any position within the template pore. In this embodiment, it is observed to occur on an external surface of the porous template on the other side of the porous template. Alternatively, reduction of the metal reagent of the first solution may occur within a pore of the porous template, as described in FIGS. 2-3. The nanowire synthesis proceeds for a predetermined amount of time, preferably between 1 second and 24 hours, and may proceed longer than 24 hours to fill the pores of the porous template.

The first solution and the second solution are provided in a solvent including at least one of water (H₂O) and an alcohol, and mixtures thereof. The nanowire is synthesized with the solvent in a liquid state. Specifically, a temperature of the first solution and the second solution is above the melting point and below the boiling point of the solvent, and preferably at ambient conditions. However, heating of the first and second solutions during the nanowire synthesis provides a more rapid formation of the nanowires and promotes formation of polycrystalline nanowires. Additionally, cooling the first and second solutions during the nanowire synthesis slows the growth of the nanowire and promotes formation of single crystalline nanowires.

In step 407, the porous template is removed from the vessel with the synthesized nanowires contained therein. The nanowires can be isolated as either a solid powder or as free-standing nanowire arrays.

The synthesized nanowire includes a single transition metal, such as palladium, gold, ruthenium, and platinum. The nanowire and surface thereof are substantially free of organic contaminants and impurities. Dimensions, i.e., diameter and length, of the nanowire are defined by respective dimensions of the pore. Nanowire length is also determined by concentration of metal reagent in the first solution, concentration of the reducing agent in the second solution, and reaction time.

The metal salt of the metal reagent preferably includes a metal cation of the transition metal, actinide metal or the lanthanide metal of the metal salt, with a corresponding anion including at least one of halides, oxides, acetates, acetyl-acetates, nitrates, phosphates, sulfates, sulfides, citrates, hydroxides, amine halides, amine hydroxides, hydrogen halides, alkali halides, ethylenediamine halides, hydrogen hydroxides, cyanides and carbonates.

The reducing agent preferably includes at least one of metal borohydrides, sodium cyanoborohydride, metals (Na, Li, K, Rb, Cs, Mg, Ca, Al, Zn etc.), citric acid, citrate anion, ascorbic acid, ascorbate anion, formic acid, formate anion, oxalic acid, oxalate anion, lithium aluminum hydride, diborane, alpine borane, hydrogen gas, hydrazine, and 2-mercaptoethanol etc. High concentrations of the reducing agent in the second solution tend to promote formation of polycrystalline nanostructures, while low concentrations of the reducing agent tend to promote the formation of single crystalline nanostructures.

Specific examples of preferred embodiments of synthesized elemental nanowires, i.e. nanowires composed of only one metal, are provided below, with Example 1 relating to synthesis of elemental palladium nanowires; Example 2 relating to synthesis of elemental ruthenium nanowires; Example 3 relating to synthesis of elemental platinum nanowires; and Example 4 relating to synthesis of elemental gold nanowires, each utilizing the U-tube double diffusion vessel, as described with respect to FIGS. 1-4.

### 1. Elemental Palladium Nanowires

Elemental palladium nanowires were synthesized by adding sodium hexachloropalladate hydrate (87.5 mg Na₂PdCl₆.xH₂O, Alfa Aesar 99.9%) to a first solution of 5 mL of a solvent, such as water, ethanol, or absolute ethanol, and mixtures thereof. Solubility of the Na₂PdCl₆ was higher in ethanol than in water. Thus, ethanol represented a preferred solvent for the synthesis of palladium nanowires. Sodium borohydride (NaBH₄, Alfa Aesar 98%) was added to a second solution to form a 5 mM solution of sodium borohydride in 5 mL of a solvent, such as water, ethanol, or absolute ethanol, and mixtures thereof, followed by sonication. Commercially available polycarbonate porous membrane templates (Whatman, Nucleopore—track etched) with pore sizes of either 200 nm or 15 nm were sonicated in ethanol to saturate the pores.

The ethanol saturated porous template was disposed in a center point of the U-tube vessel and half-cells of the U-tube vessel were filled with the first solution and the second solution including the sodium hexachloropalladate hydrate and the sodium borohydride, respectively. Visible formation of a metallic surface on an external surface of the porous template occurs after 16 minutes of reaction time in the case of the 200 nm template, and 4-6 minutes of reaction time in the case of the 15 nm template, signaling reaction completion.

Nanowire length is controlled by concentration of sodium hexachloropalladate in the first solution, NaBH₄ in the second solution or the reaction time, as follows. The length of the isolated nanowires prepared in 200 nm template pores increased from 0.92±0.35 μm to 4.7±1.2 μm as the reaction time is increased from two minutes to sixteen minutes. The length of the isolated nanowires prepared in the 15 nm template increased from 1.0±0.4 μm to 3.6±1.2 μm by increasing the concentration of the first solution containing the sodium hexachloropalladate from 5 mM to 36.7 mM, while the concentration of the second solution containing NaBH₄ was maintained at 5 mM. The length of the nanowires prepared in the 15 nm template increased from 0.97±0.60 μm to 3.2±1.2 μm by decreasing the concentration of the second solution containing the NaBH₄ from 250 mM to 1 mM, while the concentration of the first solution containing the Na₂PdCl₆ was maintained at 36.7 mM.

The porous template was removed from the U-tube vessel and rinsed with ethanol. Residual metal present on the external surfaces of the porous template was physically removed by polishing the template on a commercially available, soft Arkansas Wet-Stone with a mineral oil lubricant. The porous template was dissolved by immersion in methylene chloride for at least fifteen minutes and the synthesized palladium nanowires were isolated by centrifugation. The steps of immersion in methylene chloride and centrifugation are repeated at least three times for complete removal of residual organic contaminants. Subsequently, the isolated palladium nanowires are purified by washing with ethanol. A catalyst ink for use in electrochemical measurements was prepared by dispersing the isolated palladium nanowires into 25% isopropyl alcohol in water. The catalyst ink was applied to an electrode for measurement of electrochemical performance, as described below. Free standing arrays of the palladium nanowires were obtained by affixing the porous template onto a silicon wafer with double-sided copper tape and exposing the porous template and the wafer to oxygen plasma for twenty minutes in a reactive ion etcher (March Plasma).

1.a. Characterization of Palladium Nanowires

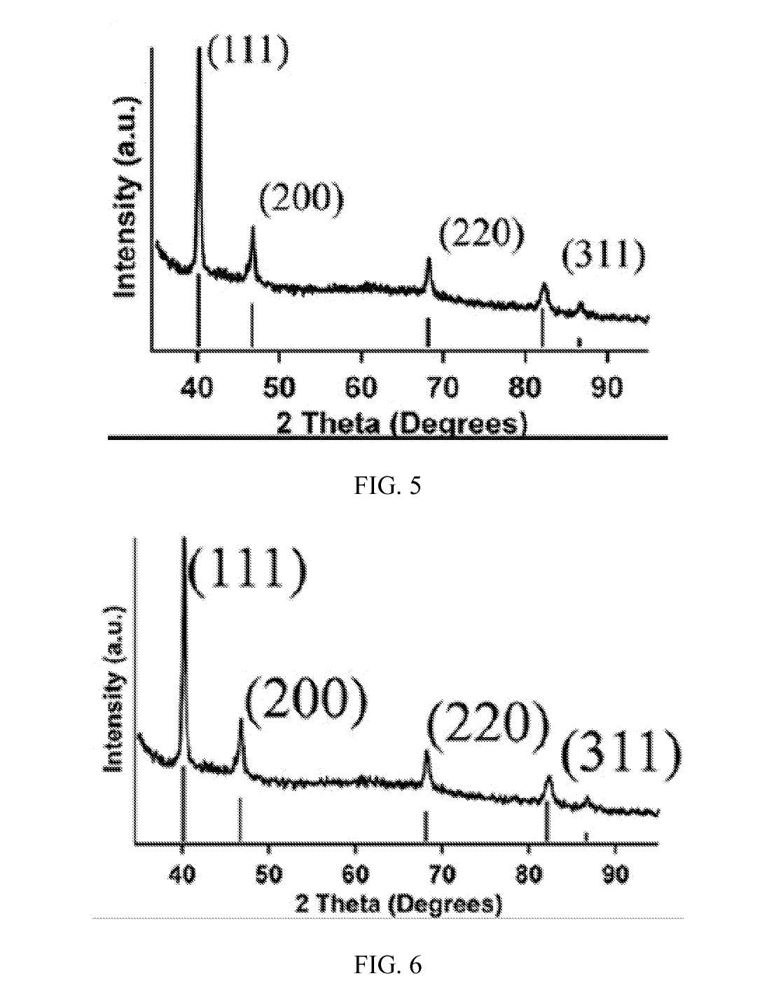

FIGS. 5-6 are powder X-Ray Diffraction (XRD) graphs of palladium nanowires synthesized using templates of 15 nm and 200 nm pore size. Specifically, FIG. 5 illustrates an XRD graph of the palladium nanowires synthesized using a 15 nm porous template and FIG. 6 illustrates an XRD graph of the palladium nanowire synthesized using a 200 nm porous template. FIGS. 5 and 6 indicate that the nanowires are composed of crystalline palladium. Crystallographic analysis confirms that all of the peaks for the palladium nanowires prepared in templates composed of 200 nm and 15 nm pores are assigned to the (111), (200), (220), and (311) reflections of face-centered cubic palladium, consistent with an Fm3m standard provided by the Joint Committee for Powder Diffraction Standards (JCPDS) No. 46-1043. D-spacing for the (111) reflection of palladium of 2.243 Å isolated from the palladium nanowires is in agreement with a standard value of 2.245 Å. The absence of any other peaks in FIGS. 5 and 6 confirms that the nanowires are substantially free of any impurities.

XRD graphs were obtained using copper Kα radiation with a wavelength of 1.5 Å at a scan rate of 0.4 degrees in 20 per minute intervals, utilizing a Scintag diffractometer operating in a Bragg-Brentano configuration. XRD samples were prepared by creating an ethanolic slurry with the palladium nanowires and allowing to air dry.

Diameters of the nanowires can be controlled by changing the pore diameter of the porous template. Specifically, the palladium nanowires can be prepared with diameters of 45±9 nm and 270±45 nm, when commercially available porous templates with pore diameters of 15 nm and 200 nm are used.

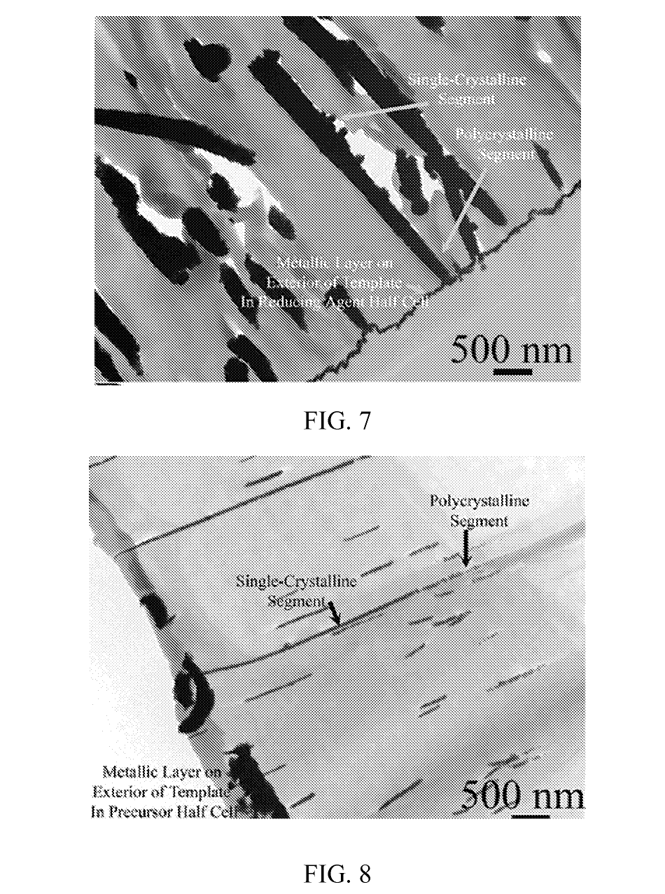

FIGS. 7-18 are Transmission Electron Microscopy (TEM) and Scanning Electron Microscopy (SEM) images of the synthesized palladium nanowires. FIG. 7 is a TEM image obtained from a cross-section of the porous template containing the palladium nanowires before being isolated from the 200 nm polycarbonate porous template. FIG. 8 is a TEM image obtained from a cross-section of the porous template containing the palladium nanowires before being isolated from the 15 nm polycarbonate porous template. FIGS. 7-8 show that the synthesized palladium nanowires have diameters of 45±9 and 270±45 nm with aspect ratios of 73±22 nm and 13±4 nm, for palladium nanowires synthesized using the 15 and 200 nm porous templates, respectively. The size discrepancy between commercially reported pore diameter of the porous templates and experimentally measured diameters of the palladium nanowires is generally attributed to variation of the diameter of the pores within the interior of the porous template in combination with swelling of the pores during growth of the nanowires. As shown in FIGS. 7-8, growth of the nanowire beyond the length of pore results in formation of a thin metal surface on the external surface of the porous template to which the nanowires are affixed.

FIGS. 7-8 indicate that the polycrystalline segment includes a first 200-500 nm of the palladium nanowire affixed onto the metallic surface of the palladium nanowire, which in the case of FIG. 7, is formed on the external surface of the porous template. The polycrystalline texture of the polycrystalline segment may arise from rapid reaction kinetics when the reducing agent directly interacts with and reduces the palladium metal reagent, a mechanism favoring formation of discrete nuclei as opposed to crystalline growth. FIGS. 7-8 indicate that the polycrystalline segment transforms into a uniform homogeneous single crystalline segment toward an interior of the pores of the porous template.

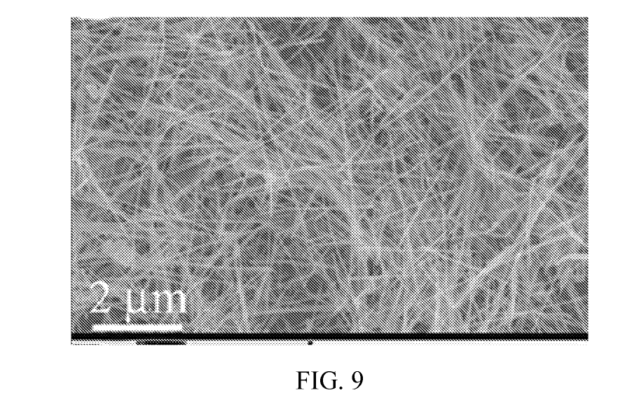

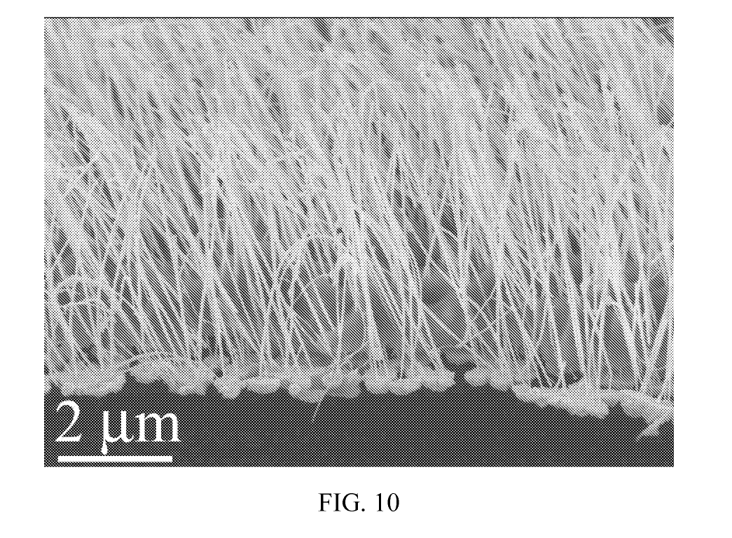

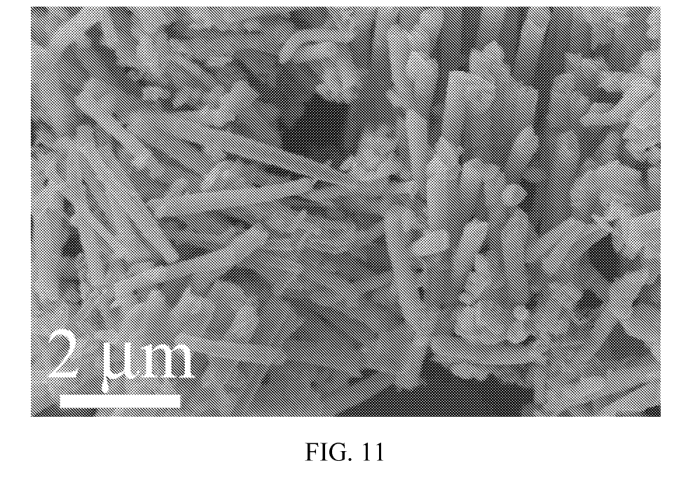

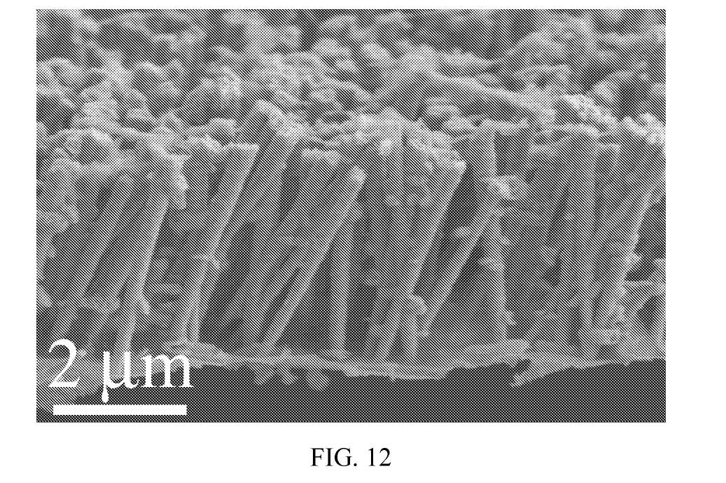

FIGS. 9-12 are SEM images of palladium nanowires synthesized using 15 nm and 200 nm templates. FIG. 9 is an SEM image taken after the 15 nm porous template is removed for the isolated palladium nanowires. FIG. 10 is an SEM image taken after the 15 nm porous template is removed for a free-standing array of the palladium nanowires. FIG. 11 is an SEM image after the 200 nm porous template is removed for the isolated palladium nanowires. FIG. 12 is an SEM image after the 200 nm porous template is removed for a free-standing array of the palladium nanowires.

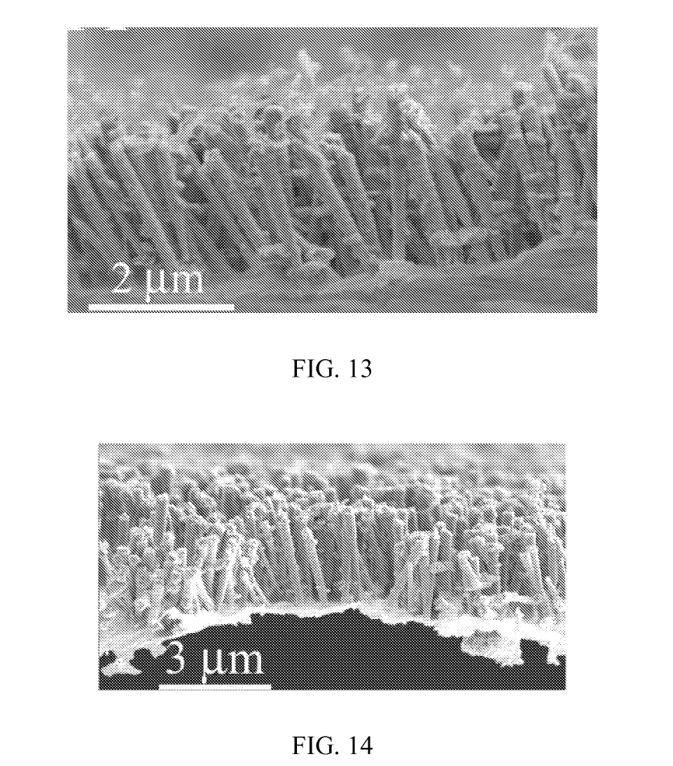

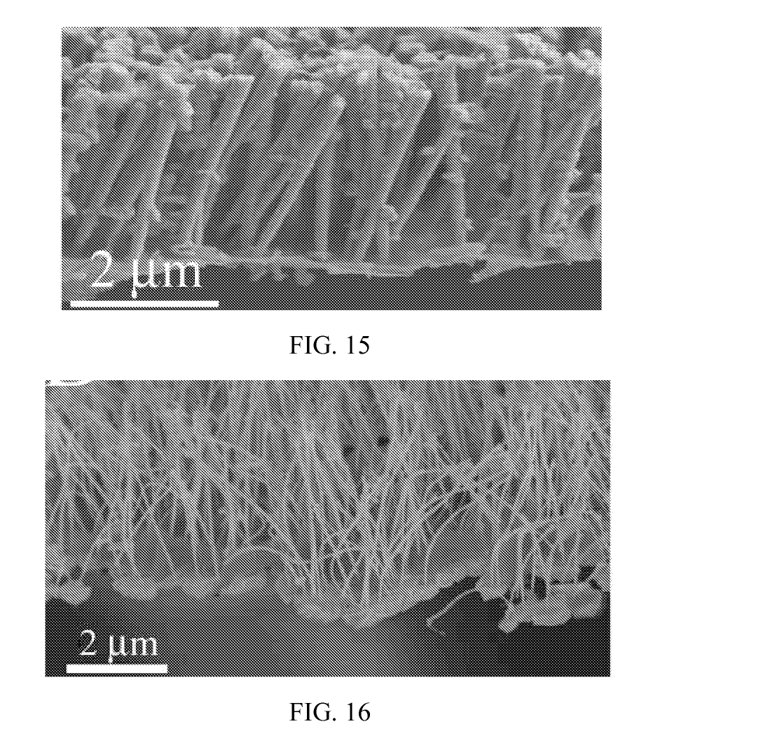

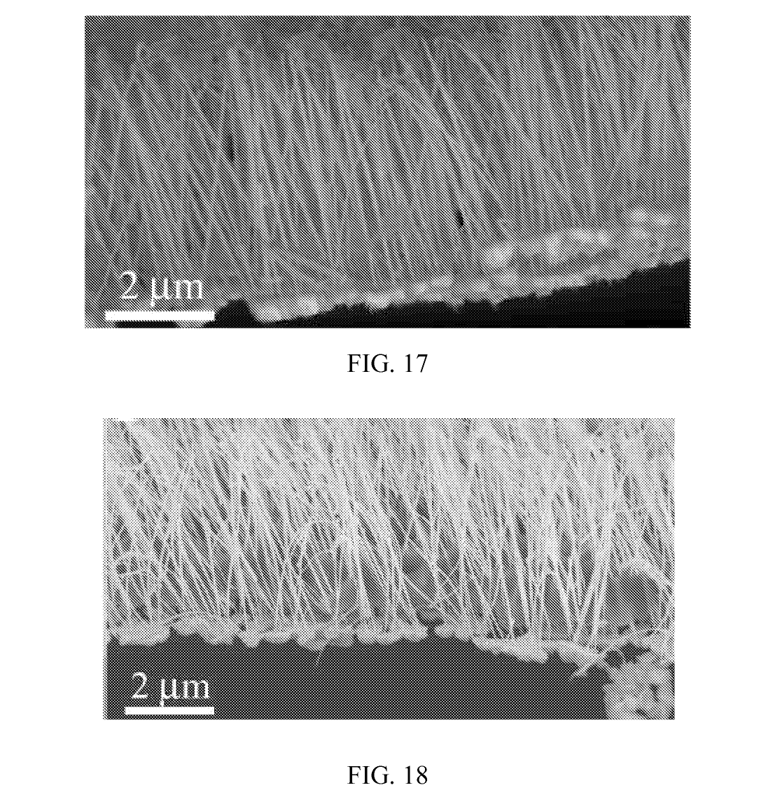

FIGS. 13-15 are SEM images of palladium nanowire arrays prepared in 200 nm templates. FIGS. 16-18 are SEM images of palladium nanowire arrays prepared in 15 nm diameter porous templates. FIGS. 13 and 16 are SEM images of palladium nanowire arrays, isolated after reaction times of four minutes. FIGS. 14 and 17 are SEM images of palladium nanowire arrays, isolated after reaction times of 8 minutes. FIGS. 15 and 18 are SEM images of palladium nanowire arrays, isolated after reaction times of 12 minutes. FIGS. 13-15 illustrate that increasing the reaction time in the synthesis of the palladium nanowires prepared in 200 nm template pores from four minutes to twelve minutes resulted in an increase of nanowire length from approximately 2 μm to over 3 μm.

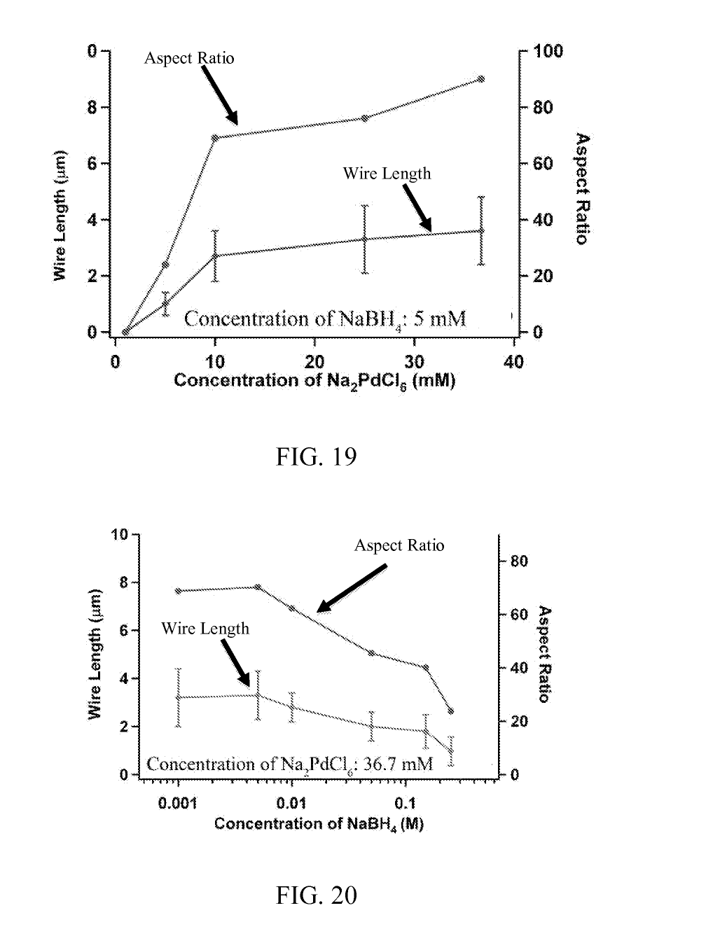

For palladium nanowires prepared in the 15 nm template pores, FIGS. 16-18 indicate that there is minimal change in nanowire length when isolated as a free-standing array, as the time is varied between four and twelve minutes. The length of these nanowires depends on the concentration of the first and second solutions, as shown in and described with respect to FIGS. 19-20.

SEM images of individual isolated nanowires were obtained from samples prepared by dispersing the palladium nanowires in ethanol. After a brief period of sonication, the palladium nanowires were added drop-wise onto clean silicon wafers. For the free-standing nanowire arrays, the arrays affixed to the silicon substrates prepared by the procedure described above were imaged, as-prepared. SEM images were obtained, utilizing field emission electron microscopes (Leo 1550 and Hitachi S4800) at an operating voltage of 15 and 5 kV, respectively.

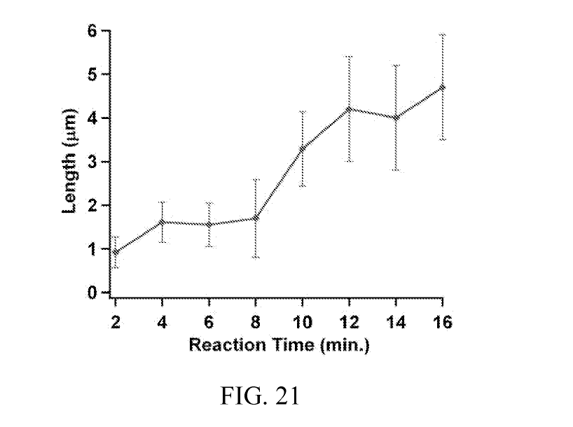

FIGS. 19-20 are graphs showing correlation of wire length and aspect ratio to concentration of Na₂PdCl₆ and NaBH₄, respectively, and FIG. 21 is a graph correlating nanowire length with reaction time, for palladium nanowires synthesized according to the above-described method. The length of the palladium nanowires was controlled by changing one of the concentration of the first solution, the concentration of the second solution, and the reaction time. FIG. 19 illustrates that the length, measured by SEM, of the individual palladium nanowires prepared in the 15 nm template increased from 1.0±0.4 μm to 3.6±1.2 μm by increasing the concentration of the first solution containing the Na₂PdCl₆ from 5 mM to 36.7 mM, while the concentration of the second solution containing NaBH₄ is maintained at 5 mM. FIG. 20 illustrates that the length of the palladium nanowire prepared in 15 nm template pores increased from 0.97±0.60 μm to 3.2±1.2 μm by decreasing the concentration of the second solution containing NaBH₄ from 250 mM to 1 mM, while the concentration of the first solution containing Na₂PdCl₆ was maintained at 36.7 mM.

FIG. 21 illustrates dependence of a length of the palladium nanowires isolated from the 200 nm templates as a function of the reaction time. FIG. 21 shows that increasing reaction time of the palladium nanowires from two minutes to sixteen minutes prepared in the 200 nm template pores leads to an increase in the length of the isolated nanowires from 0.92±0.35 to 4.7±1.8 μm. These results are consistent with the results of illustrated in FIG. 13-15, which also show an increase in the length of the palladium nanowires as the reaction time increases.

FIGS. 13-21 indicate that the length of the palladium nanowires can be controlled by either concentration of the metal reagent in the first solution, concentration of the reducing agent in second solution, and reaction time, and combinations thereof. The porous templates had a pore length of approximately 6 μm and the measured lengths of palladium nanowires prepared from 200 nm and 15 nm porous templates ranged from approximately 1 μm to 5 μm, without exceeding the pore length.

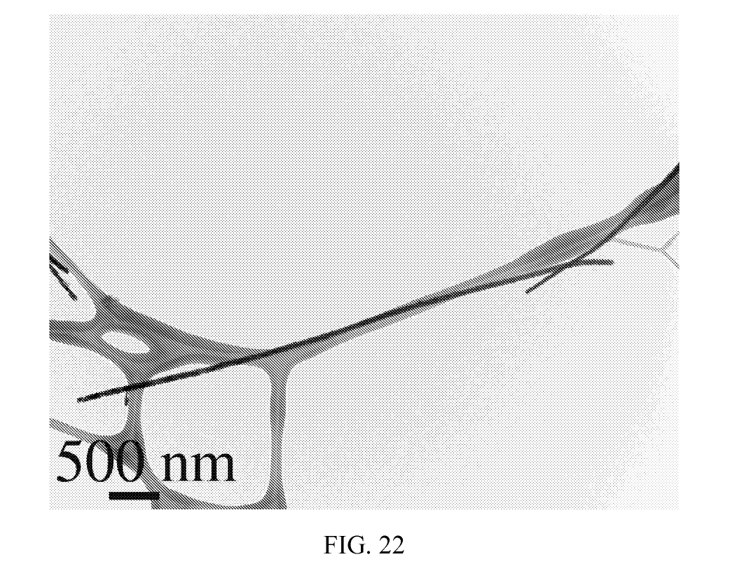

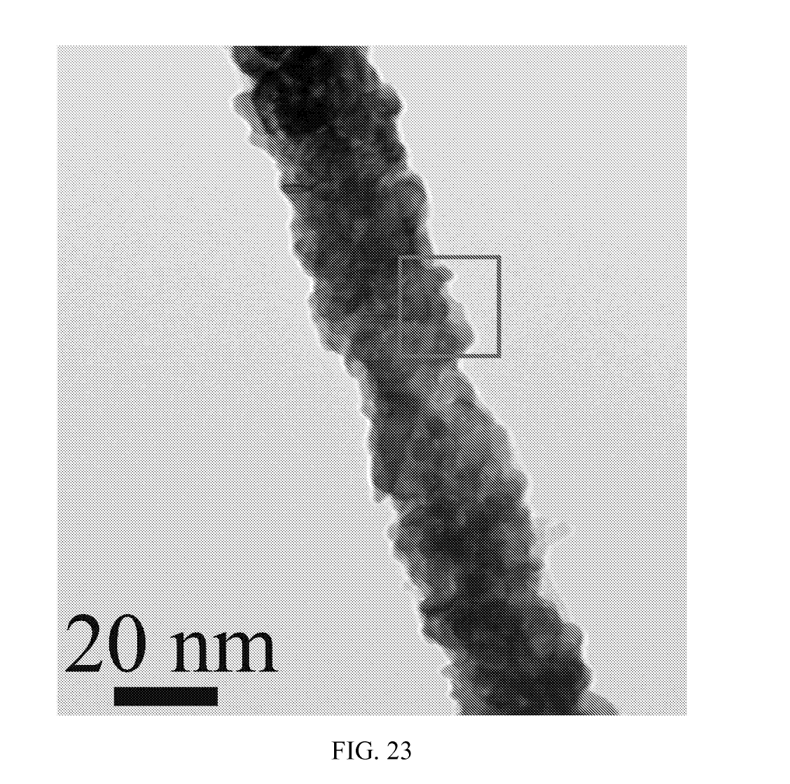

FIGS. 22-28 are TEM and High Resolution TEM (HRTEM) images of palladium nanowires synthesized using templates of 15 nm and 200 nm pore size. FIGS. 22-28 confirm quality and high aspect ratio of the palladium nanowires and indicate that the palladium nanowires maintain uneven, roughened surfaces, likely originating from a textured surface structure of the pores of the porous template.

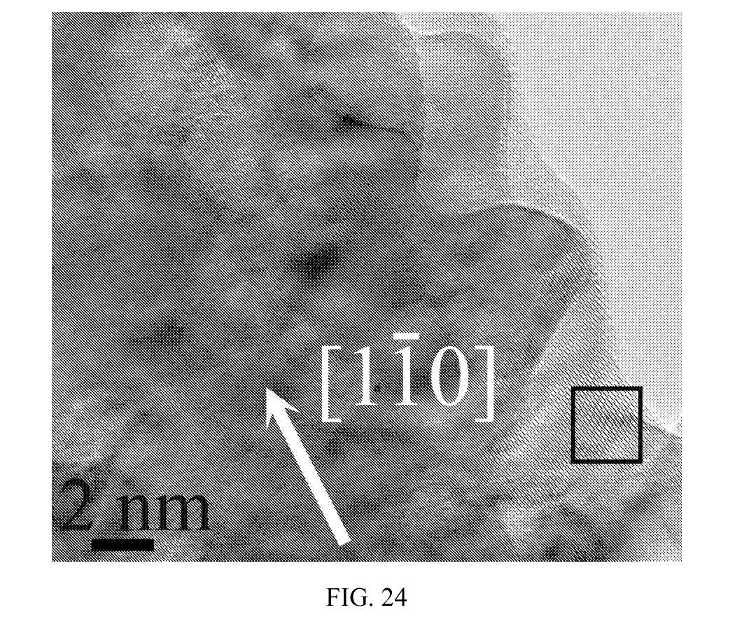

FIG. 22 is a TEM image of a palladium nanowire synthesized using a 15 nm template. FIG. 23 is a magnified image of the nanowire in FIG. 22 with a box showing a location of the HRTEM image provided in FIG. 24, which illustrates that the palladium nanowires are formed along a [1 1̅0] crystallographic direction.

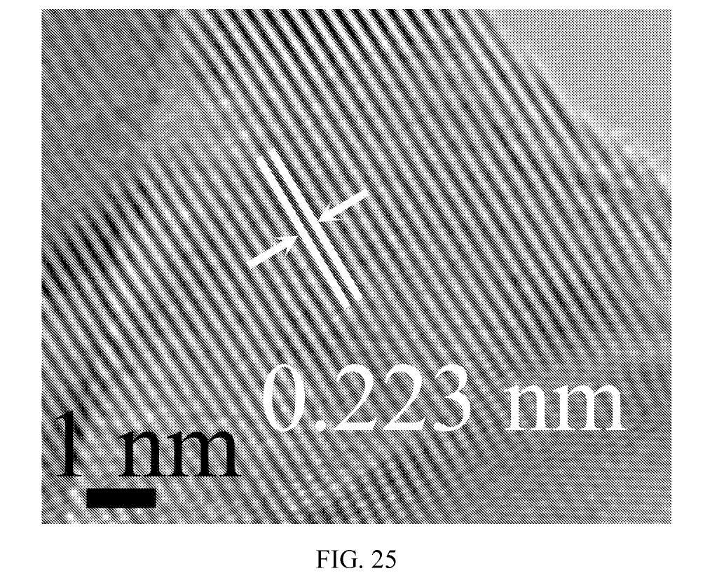

FIG. 25 is a HRTEM image indicating visible lattice planes of the palladium nanowires, taken from the location of the box portion shown in FIG. 24. Inter-planar spacing indicated by the lines and arrows drawn in FIG. 25 is measured to be 0.223 nm and is consistent with the (111) lattice spacing of palladium of 0.225 nm. FIG. 25 indicates that the palladium nanowires are substantially free of impurities with only lattice planes associated with palladium being visible, and not showing any other impurity, such as palladium oxide, palladium chloride or organic contaminants.

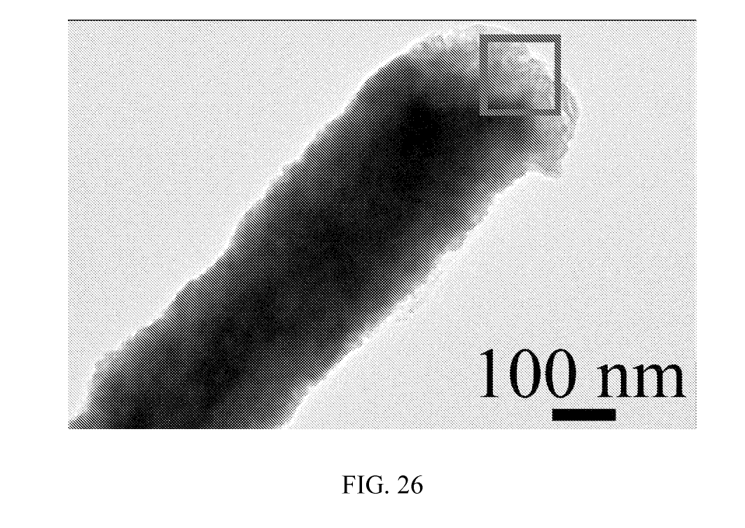

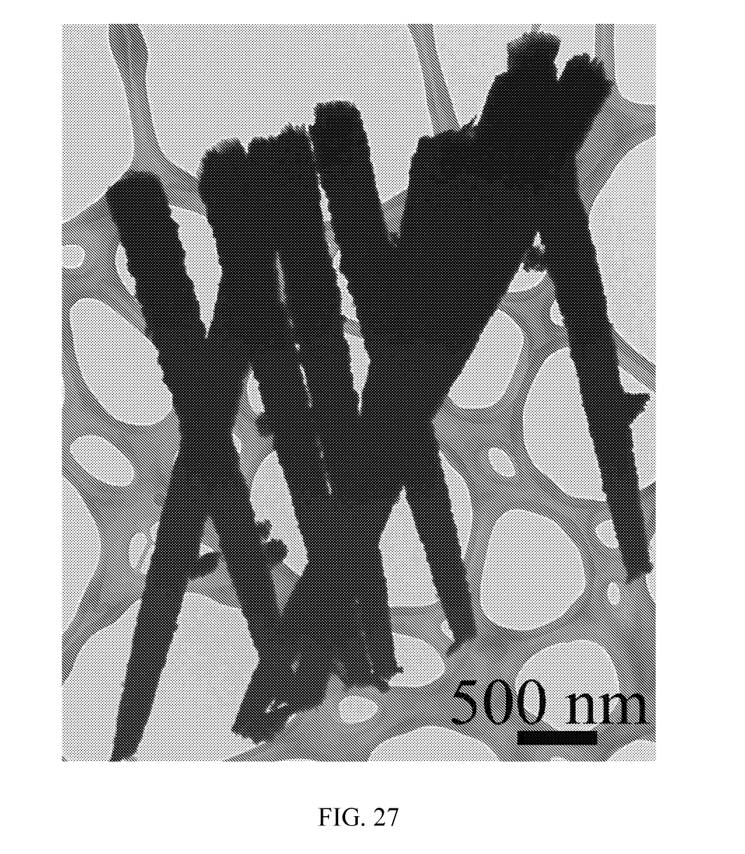

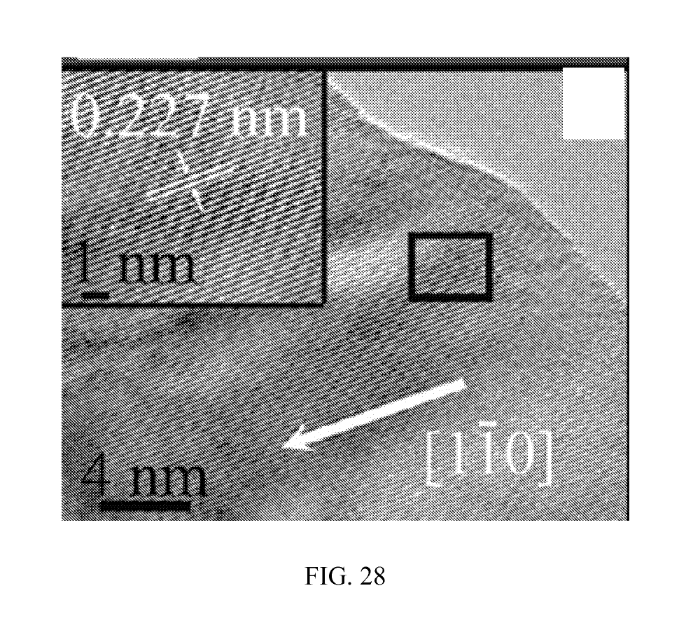

FIG. 26 is a magnified TEM image of a palladium nanowire synthesized using a 200 nm template. FIG. 27 provides a reduced magnification of the palladium nanowires used to obtain the TEM image of FIG. 26. The box in FIG. 26 indicates a location of the HRTEM image of FIG. 28, which illustrates that the palladium nanowires are formed along a [1 1̅0] crystallographic direction. An inset portion of FIG. 28 was taken from the box portion in FIG. 28. The inter-planar spacing indicated by the lines and arrows drawn in the inset of FIG. 28 is measured to be 0.227 nm and is consistent with the (111) lattice spacing of palladium of 0.225 nm. The inset to FIG. 28 indicates that the palladium nanowires are substantially free of impurities since only lattice planes associated with palladium are visible and no other impurity phases or organic contaminants are visible.

FIGS. 24 and 28 illustrate that the palladium nanowires are single-crystalline, with the exception of a polycrystalline segment at an end of the palladium nanowire. The polycrystalline segment is likely attributed to, and a consequence of, the nucleation step.

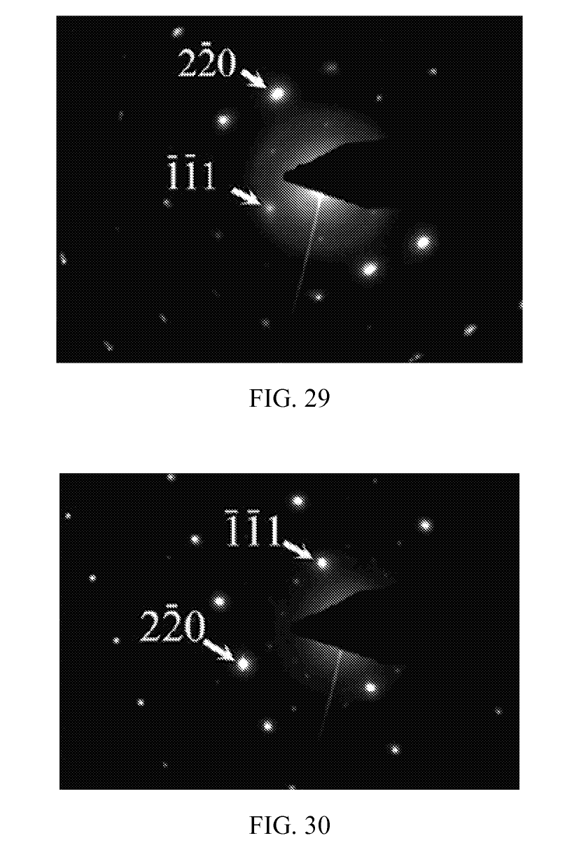

FIGS. 29-30 are Selected Area Electron Diffraction (SAED) images of the synthesized palladium nanowires. FIG. 29 illustrates an SAED image corresponding to the TEM image of FIG. 23. FIG. 30 illustrates a SAED image corresponding to the TEM image of FIG. 26. FIGS. 29-30 provide diffraction patterns taken along a length of the palladium nanowires demonstrating that the palladium nanowires are single crystalline over a majority of the length. The diffraction patterns of FIGS. 29-30 were obtained with an electron beam incident along a [112] axis of palladium. The diffraction patterns of FIGS. 29-30 and the HRTEM images of FIGS. 24 and 28 indicate that a long axis of the palladium nanowires formed in both the 200 nm and 15 nm pores are oriented along the [1 1̅0] crystallographic direction. The growth direction of the palladium nanowires may arise from the relatively slow reduction kinetics observed using this synthetic method. Additionally, FIGS. 29-30 indicate that the palladium nanowires are substantially free of impurities, since all discrete diffraction spots are assigned to reflections of the palladium lattice and no other diffraction spots or rings associated with impurities are present.

HRTEM and SAED images were acquired using an FEI Titan 80-300 TEM equipped with a Cs-corrector, operated at 300 kV. TEM samples of individual palladium nanowires were prepared by dispersing the palladium nanowires in a solution of ethanol and evaporating a drop of the ethanol solution onto a 300 mesh copper grid, coated with a lacey carbon film.

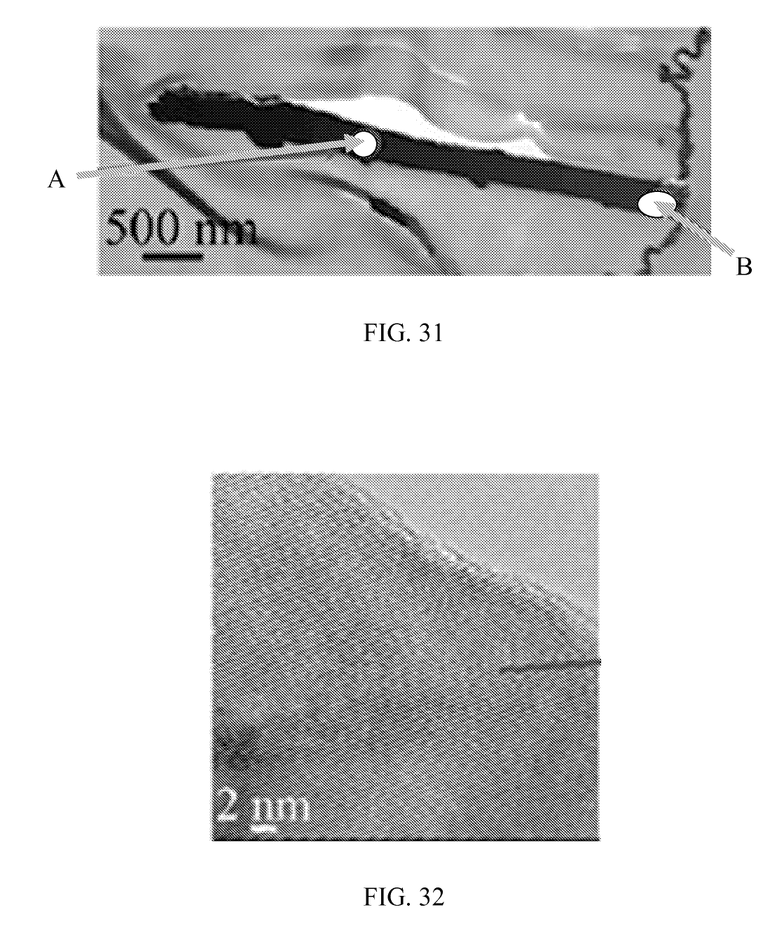

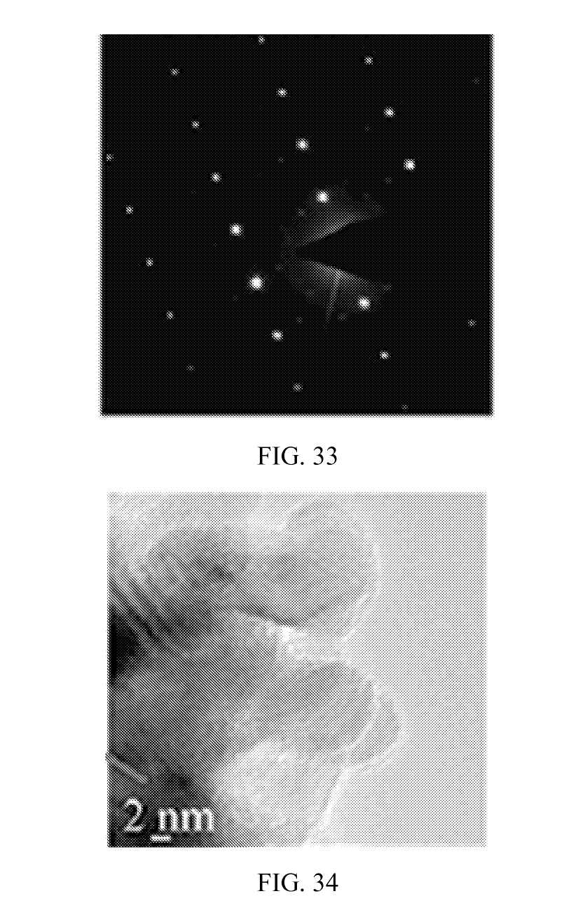

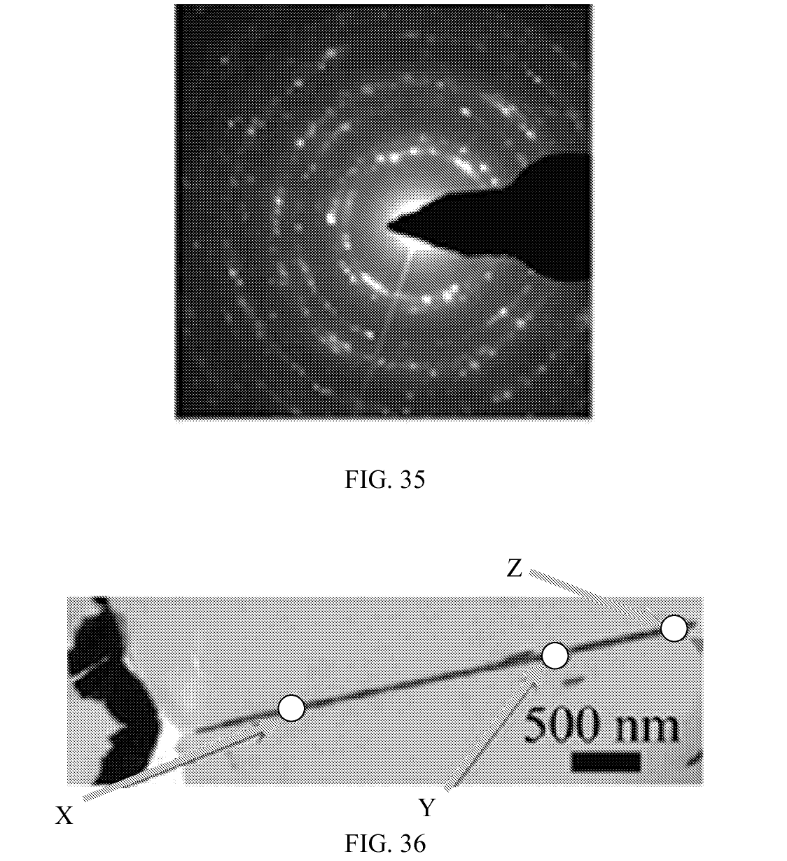

FIGS. 31-35 and FIGS. 36-41 are HRTEM and SAED images of the single crystalline and polycrystalline segments denoted in the TEM images of FIGS. 7 and 8, respectively. FIG. 31 is a TEM image of a single nanowire from the cross-section of the template shown in FIG. 7. FIG. 32 is an HRTEM image obtained from the palladium nanowire at location A of FIG. 31. FIG. 33 is an SAED pattern obtained from the palladium nanowire at location A of FIG. 31. FIG. 34 is an HRTEM image obtained from the palladium nanowire at location B of FIG. 31. FIG. 35 is an SAED pattern obtained from the palladium nanowire at location B of FIG. 31.

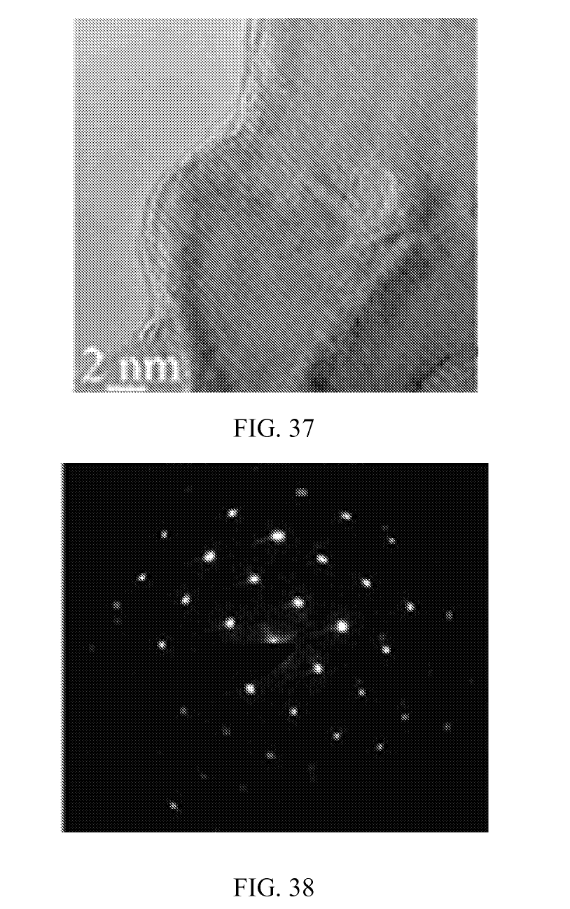

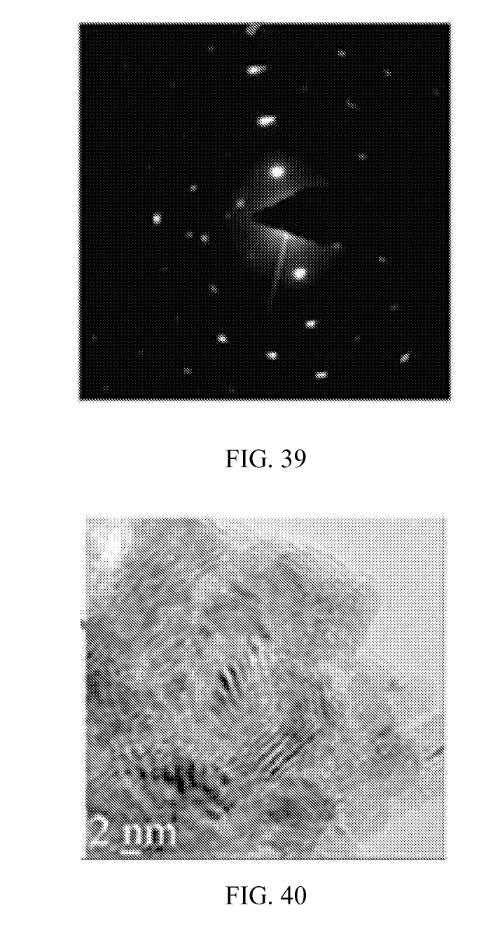

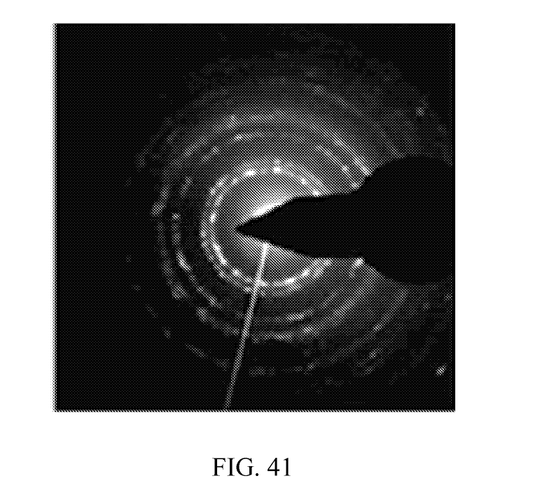

FIG. 36 is a TEM image of a single nanowire from the cross-section of the template shown in FIG. 8. FIG. 37 is an HRTEM image obtained from the palladium nanowire at location X of FIG. 36. FIG. 38 is an SAED pattern obtained from the palladium nanowire at location X of FIG. 36. FIG. 39 is an SAED pattern obtained from the palladium nanowire at location Y of FIG. 36. FIG. 40 is an HRTEM image obtained from the palladium nanowire at location Z of FIG. 36. FIG. 41 is an SAED pattern obtained from the palladium nanowire at location Z of FIG. 36.

FIGS. 31-41 indicate that the palladium nanowires are composed of both a polycrystalline segment and a single crystalline segment. Accordingly, the polycrystalline segment representing approximately 1 μm of the palladium nanowire evolved into the single crystalline segment that includes the remaining 3-4 μm of the palladium nanowire.

As illustrated by FIGS. 31 and 36, locations A and X, respectively, of the palladium nanowires confirm that the single crystalline segment of the nanowire is single crystalline with highly resolved lattice planes running across the single crystalline segment. The diffraction spots, present on the corresponding SAED images in FIGS. 33 and 38, further demonstrate the single crystalline nature of the single crystalline segment. The single-crystalline segment growth observed in pores of the porous template may occur through an in situ electroless deposition process where a reduction rate of the palladium metal reagent is slowed. A slower reduction rate allows crystalline growth to predominate as opposed to rapid nucleation growth. Formation of the polycrystalline segment and the metallic surface prevents direct diffusion of the palladium and borohydride ions into the template pores, thereby preventing direct reduction of the palladium. Thus, the metallic surface and the polycrystalline segment may serve as a conductive layer through which electrons transfer from the reducing agent half-cell toward the interior of the pores, thereby reducing the palladium within the pores and resulting in growth of the single crystalline segment toward the palladium half-cell.

Electrochemical neutrality may be maintained during this mechanism by corresponding diffusion of positive sodium (Na⁺) counter-ions from the reducing agent half-cell into the palladium metal reagent half-cell. Dispersed spaces within the porous template may provide channels for diffusion of the counter-ions. Although plausible routes for Na⁺ ion diffusion may exist, a description of a precise mode of counter-ion diffusion is beyond the scope of this application.

In the case of the 200 nm template pores, FIGS. 7 and 31 illustrate that the nucleation of the nanowire is initiated at the surface B of the porous template and the second solution resulting in the initial formation of the metallic surface on the external surface of the template exposed to the second solution. In the case of the 15 nm template pores, FIGS. 8 and 36 illustrate that nucleation occurs at an interior surface Z of the pores of the porous template. The shift in the location of the nucleation likely arises from the smaller pore size, which may limit diffusion of the metal reagent and the reducing agent into the pores of the porous template. The pores have a cylindrical shape. Thus, the point of contact between the first solution and the second solution appears to shift toward the interior of the pores. Accordingly, the primary nucleation occurs at the interior of the pores, closer toward the first solution than in the case of the 200 nm porous template. In both cases, however, crystalline growth of the nanowire toward the first solution proceeds beyond the template pore, forming a metallic surface on an external surface of the porous template in the metal reagent half-cell. FIGS. 8 and 36 illustrate formation of the metallic surface on the external surface of the first solution side of the porous template affixed onto the nanowires within the template.

Growth of the palladium nanowires in 15 nm template pores was generally complete within 4 minutes of adding the first and second solutions to the U-tube diffusion vessel. This is consistent with observed formation of metallic material within 4-6 minutes on the external surface of the porous template in the metal reagent half-cell. By contrast, the growth of the palladium nanowires in the 200 nm template pores required approximately 20-30 minutes to fill the pore, with completion of the reaction signaled by formation of a second metallic layer on the surface of the template exposed to the first solution.

Accordingly, growth of the nanowires in both the 15 nm and 200 nm pores proceeds towards the first solution half-cell. In addition, the nanowires fill the pores of the porous template at a faster rate in the 15 nm pores as compared with the 200 nm pores. The reaction time required for the preparation of the metallic nanowires of less than 30 minutes is significant since single crystalline nanowires with high quality and purity can be prepared quickly, efficiently, and without the need for additional electrochemical equipment, toxic reaction media, or costly equipment.

The TEM images were obtained at 80 kV on a Technai 12 BioTwinG² instrument (FEI), equipped with an AMT XR-60 CCD camera system. Cross sections of the porous template were prepared by embedding the porous template in either Spurr or Epon resin, and 80 nm sections of the porous template were cut with a Reichert-Jung UltracutE ultramicrotome. The 80 nm sections of the porous template were placed onto Formvar coated slot copper grids.

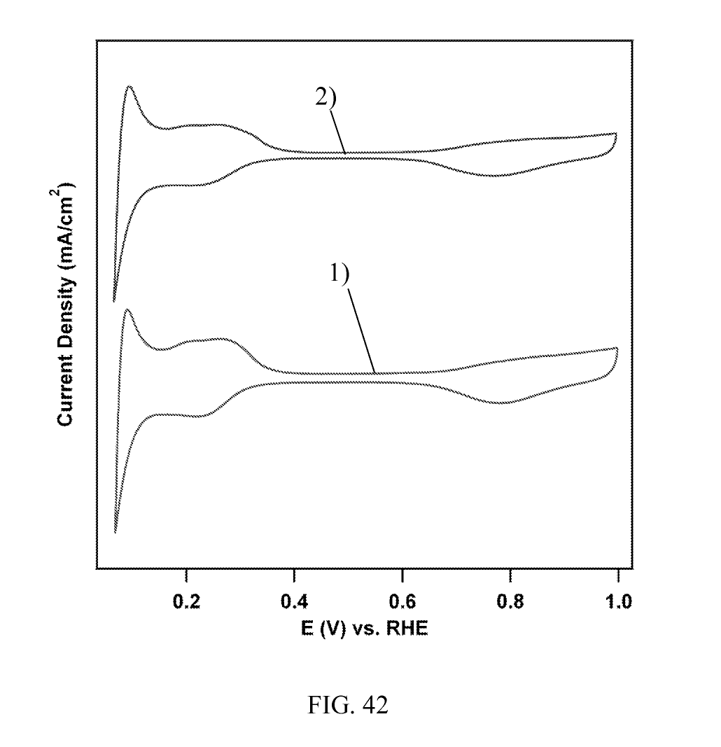

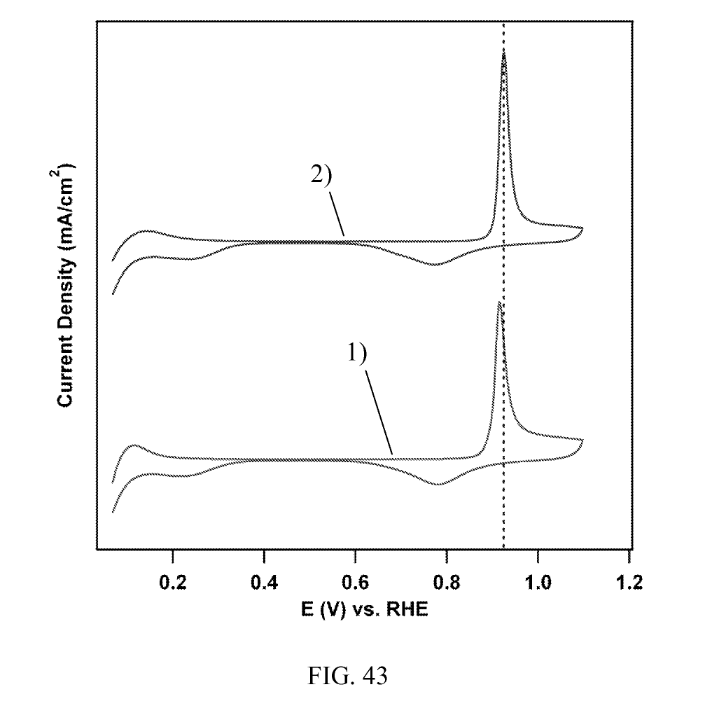

FIGS. 42-43 are graphs measuring electrochemical performance of the palladium nanowires synthesized according to the above-described method using porous templates having 15 nm and 200 nm pores. FIG. 42 illustrates Cyclic Voltammograms (CVs) and FIG. 43 illustrates Carbon Monoxide (CO) stripping CVs of the palladium nanowires including: 1) 45 nm palladium nanowires synthesized using a 15 nm porous template; and 2) 270 nm palladium nanowires synthesized using a 200 nm porous template.

In FIGS. 42-43, the current density (J) is defined as the measured current (I) normalized to the Electrochemical Surface Area (ESA), which is measured as a function of electrochemical potential (E) with respect to the Reversible Hydrogen Electrode (RHE). The ESA is determined from the CO stripping charge calculated by integrating the area under the CO stripping peaks shown in FIG. 43.

Prior to measuring electrochemical performance of the palladium nanowires, surfaces of the palladium nanowires were activated by exposure to potentials of about 1.3 V to remove remnants of the porous template. An advantage of the nanowire synthesis method described herein is that nanowires can be prepared, purified, and isolated without using surfactants, which hinder electrochemical performance. By contrast, conventional nanowires supported on carbon require a two-step cleaning process involving pretreatment, such as an acid wash or Ultraviolet ozone oxidation, and electrochemical protocols, such as CO absorption, in order to remove the adsorbed octadecylamine, i.e., a surfactant.

Electrochemical performance of the activated palladium nanowires was determined by cyclic voltammetry. FIG. 42 illustrates CVs obtained in a deoxygenated 0.1 M HClO₄ solution with a scan rate of 20 mV/s. The CVs in FIG. 42 indicate hydrogen adsorption/desorption (H_{ads}) peaks at 0-0.2 V and onset of surface oxide formation at approximately 0.7 V, consistent with commercial nanoparticle palladium catalysts. Additionally, FIG. 42 illustrates H_{ads} peaks and oxide formation peaks as well as an absence of any peaks associated with organic contaminants confirming that the palladium nanowires are substantially free of organic contaminants.

FIG. 43 illustrates a graph of CO stripping CV of the palladium nanowires. A CO stripping charge was used to estimate the ESA because, in the case of palladium, absorption of hydrogen into a lattice of palladium can contribute to the measured H_{ads} charge, rendering an accurate determination of surface area difficult. Further, as illustrated in FIG. 43, CO stripping CVs for the palladium nanowires support size-dependent enhancement in activity due to surface contraction of the palladium nanowires. A down-shift of a d-band center due to surface contracting strain may weaken CO binding strength and improve a surface diffusion rate. The CO stripping peak shifted negatively from 0.925 to 0.916 V as the size of the palladium nanowires decreased from 270 to 45 nm, indicating improved CO oxidation kinetics as the size of the palladium nanowires decreases.

The shift in the CO peak and the accompanying increase in ORR activity may be explained by a size-dependent reconfiguration of the structural and electronic properties of nanowires with sizes below 100 nm. This unique and advantageous property of noble metal nanowires leads to increased catalytic activity when size is decreased, while requiring a lower quantity of precious metal, thereby providing improvements in fuel cell efficiency and lower overall costs for device production. In addition, this observed increase in activity as the size is decreased contrasts with the results obtained from analogous nanoparticle catalysts. Thus, the palladium nanowires prepared in accordance with the method of the present invention outperform the commercial palladium nanoparticle catalysts.

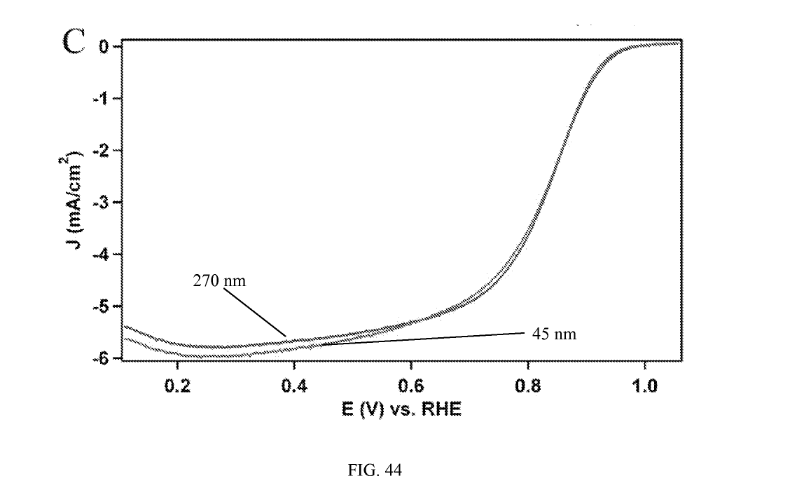

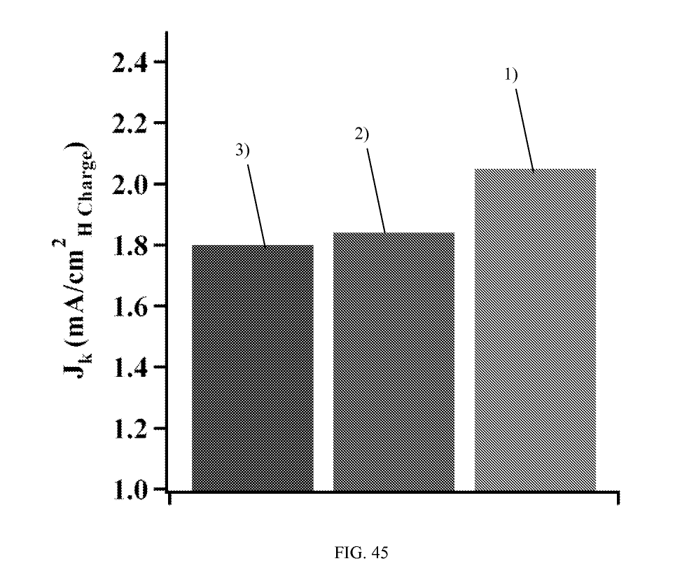

FIGS. 44-45 are a graph and a bar chart, respectively, of electrocatalytic performance of palladium nanowires synthesized according to the above-described method using templates of 15 nm and a 200 nm pore size. FIG. 44 illustrates polarization curves of the 45 nm and 270 nm palladium nanowires, which were immobilized on a Vulcan XC-72 modified glassy carbon electrode, obtained in an anodic sweep direction in an oxygen-saturated 0.1 M HClO₄ solution at 1600 rpm and 20° C. with a scan rate of 10 mV/s. FIG. 44 provides polarization curves indicating that both the 45 nm and 270 nm palladium nanowires maintained an Oxygen Reduction Reaction (ORR) onset of 0.85-0.95 V, consistent with other palladium nanostructures. Kinetic currents were extracted at 0.8 V and normalized to the ESA in order to determine specific activity of the nanostructures, which is illustrated in FIG. 45. Kinetic currents of 0.8 V were utilized, since the nanowire catalysts show insignificant activity above 0.85 V.

FIG. 45 is a bar chart of ESA activities, i.e., specific activities, calculated from the polarization curves of FIG. 44 of the palladium nanowires synthesized using 1) a 15 nm porous template, 2) a 200 nm porous template, each at 0.8 V, compared to 3) a commercially available palladium on carbon nanoparticle catalyst. FIG. 45 shows that specific activity increases from 1.84 to 2.05 mA/cm², as nanowire size decreases from 270 to 45 nm. The nanowires, particularly the 45 nm palladium nanowires, consistently and reproducibly out-perform the commercial palladium on carbon nanoparticle catalyst, which showed a specific activity of 1.80 mA/cm².

Electrochemical enhancement of the palladium nanowires compared with the commercial palladium on carbon samples may be attributed to an increased presence of the palladium (100) facet, which is significantly more active than the palladium (111) facet. Thus, enhanced activity of the synthesized palladium nanowires by comparison with commercial palladium on carbon nanoparticles may be attributed to the enhanced activity, since commercial palladium on carbon nanoparticles displays predominantly palladium (111) facets.

### 2. Elemental Ruthenium Nanowires

Elemental ruthenium nanowires were synthesized by preparing a first solution by dissolving 98 mg of potassium hexachlororuthenate hydrate (K₂RuCl₆) in 10 mL of a solvent, such as distilled water or an alcohol, for a period of 24 hrs. K₂RuCl₆ exhibited higher solubility in water than in ethanol. Thus, use of water as the solvent provided preferred conditions for formation of ruthenium nanowires. A second solution containing a reducing agent was prepared by dissolving 9.7 mg of solid sodium borohydride (NaBH₄) in 5 mL of distilled water. Commercially available polycarbonate porous templates with pore diameters of 15 and 50 nm were sonicated in distilled water to saturate the pores of the porous template. The porous template was mounted between half-cells of the U-tube vessel. The first solution and the second solution were added to the U-tube vessel and the reaction proceeded for 1 hour.

Completion of the reaction is signaled by formation of a metallic ruthenium surface on external surfaces of the porous template. The porous template was removed from the U-tube vessel, washed with distilled water, and polished on a soft Arkansas Wet-Stone (Tools for Working Wood Company, Brooklyn, N.Y.) with mineral oil as the lubricant to remove excess ruthenium metal present on the external surfaces of the porous template.

Individual ruthenium nanowires were isolated from the porous template by immersing the porous template in methylene chloride for 10 minutes, centrifuging the mixture, and decanting the supernatant to provide a solid black powder. The ruthenium nanowires were purified of organic contaminants by dispersing the powder into fresh methylene chloride, centrifuging the mixture, and decanting the supernatant. The dispersion, centrifugation, and decanting processes were repeated at least three times and the ruthenium nanowires were isolated as a purified black solid. The purified ruthenium nanowires were then dispersed into ethanol for characterization.

2.a. Characterization of Ruthenium Nanowires

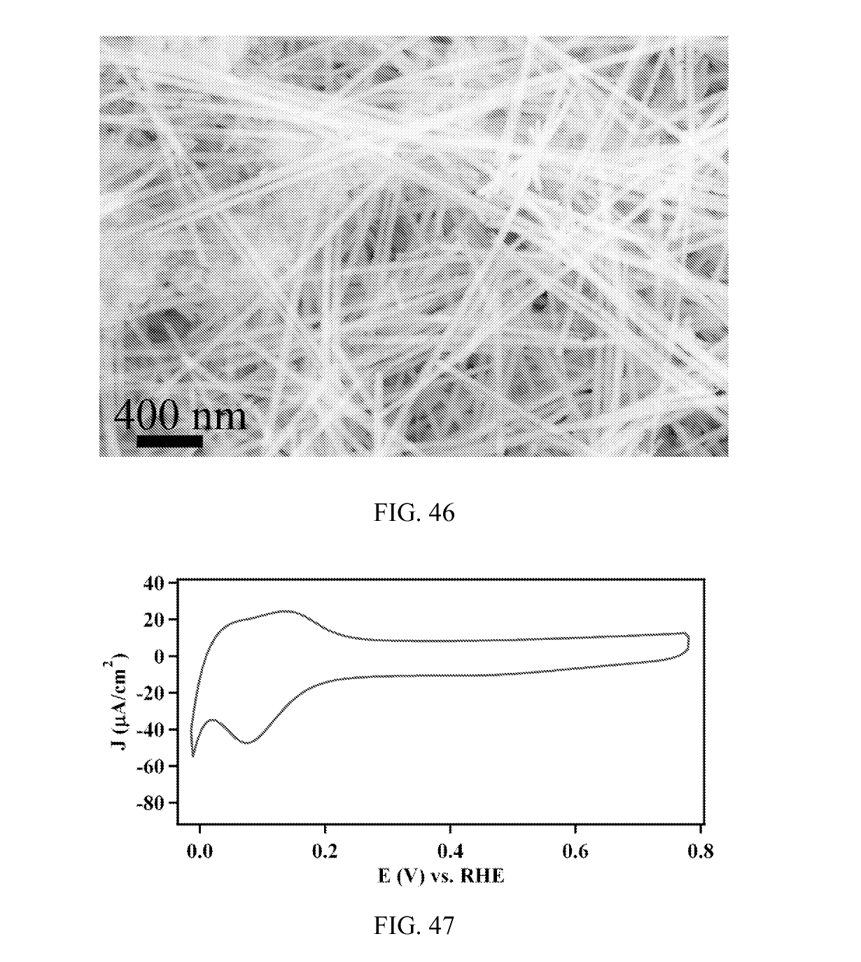

FIGS. 46-48 are an SEM image, a cyclic voltammetry graph and a powder XRD graph, respectively, of ruthenium nanowires synthesized according to the method of the present invention. FIG. 46 illustrates an SEM image obtained for the ruthenium nanowires prepared under aqueous conditions confirming that high quality, anisotropic nanowires were synthesized with diameters of 53±11 nm.

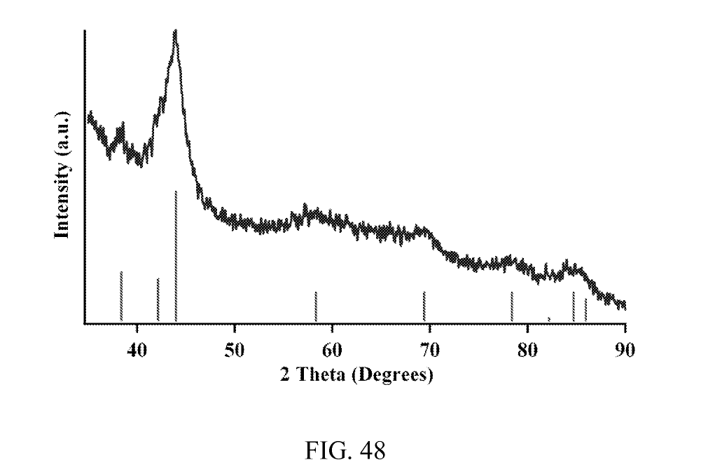

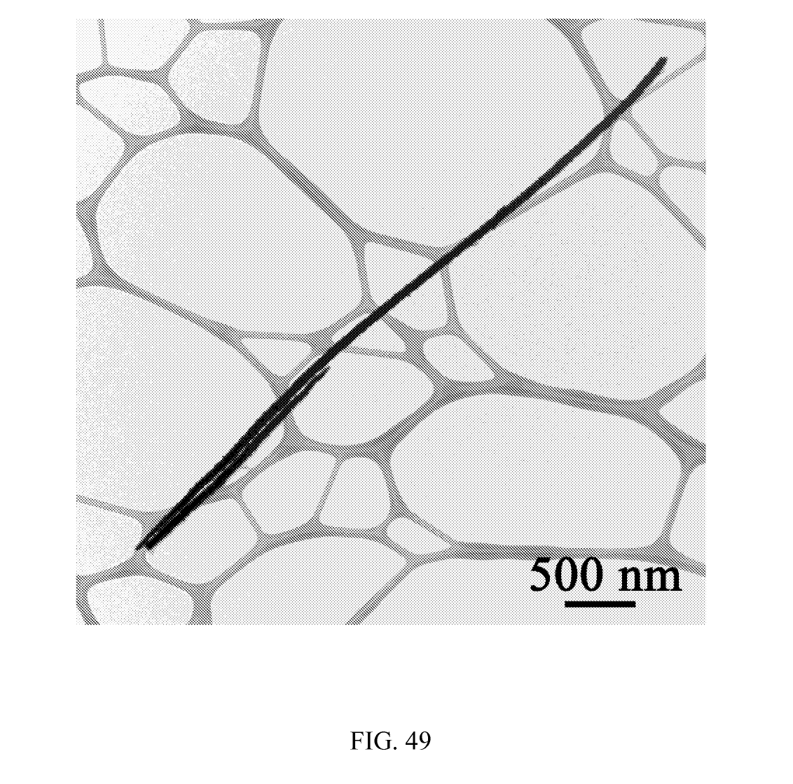

FIG. 47 illustrates a CV graph of the ruthenium nanowires supported on a glassy carbon electrode. The carbon electrode was pre-treated with a thin layer of Vulcan XC-72R carbon before depositing the ruthenium nanowires. FIG. 47 shows agreement with prior reports for ruthenium nanoparticles and ruthenium single crystals. Specifically, two cathodic features centered at 0.1 and 0.5 V in FIG. 47 are assigned, based on results obtained from ruthenium (0001) single crystals, to a sequential reduction of surface oxide monolayer (Ru—O_{ads}) to a monolayer of adsorbed hydrogen (Ru—H_{ads}). FIG. 47 also indicates that the ruthenium nanowires are substantially free of organic contaminants, confirming purity of the ruthenium nanowires. Purity is confirmed by peaks associated with hydrogen adsorption and desorption (Ru—H_{ads}) in the range of 0-0.2 V, indicating that a surface of the ruthenium nanowires is electrochemically accessible. Further, FIG. 47 provides evidence of an improvement in nanowire synthesis, since the synthesized ruthenium nanowires do not require further purification or crystallization steps prior to use as catalysts. FIG. 48 provides XRD data confirming that the ruthenium nanowires exhibit a hexagonal crystalline phase, which is desirable for catalytic and electronic applications.

### 3: Elemental Platinum Nanowires

Platinum nanowires were synthesized by substituting sodium hexachloropalladate hydrate (Na₂PdCl₆.xH₂O) employed in the synthesis of the palladium nanowires with hexachloroplatinic acid hydrate (H₂PtCl₆.xH₂O).

3.a. Characterization of Platinum Nanowires

FIG. 49 is a TEM image of platinum nanowires synthesized according to the method of the present invention, illustrating a uniform one-dimensional morphology of the platinum nanowires. FIG. 49 indicates that the platinum nanowires synthesized using a porous template with 15 nm pores have a diameter of 48±8 nm, consistent with diameters of the palladium nanowires synthesized using a porous template with 15 nm pores. Additionally, FIG. 49 indicates a similar surface texture and aspect ratio when compared with the palladium nanowires.

### 4. Elemental Gold Nanowires

Elemental gold nanowires were synthesized by substituting sodium hexachloropalladate hydrate (Na₂PdCl₆.xH₂O) employed in the synthesis of the palladium nanowires with tetrachloroauric acid hydrate (HAuCl₄.xH₂O).

4.a. Characterization of Gold Nanowires

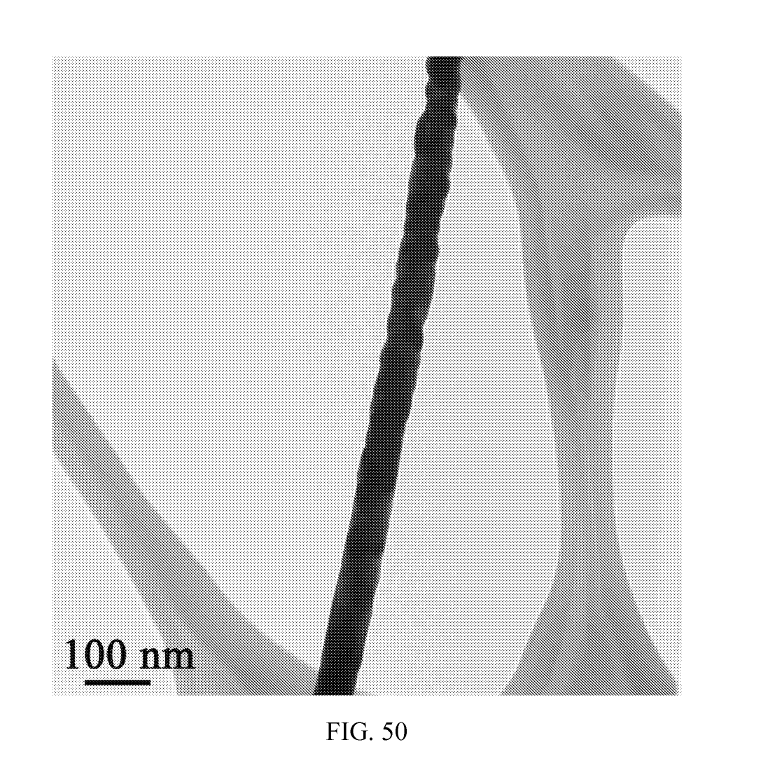

FIG. 50 is a TEM image gold nanowires synthesized according to the method of the present invention, illustrating a uniform one-dimensional morphology of the gold nanowires. FIG. 50 indicates that the gold nanowires synthesized using a porous template with 15 nm pores have a diameter of 58±8 nm, consistent with diameters of the palladium nanowires synthesized using a porous template with 15 nm pores. Additionally, FIG. 50 indicates a similar surface texture and aspect ratio, when compared with the palladium nanowires.

Accordingly, synthesis via a U-tube double diffusion vessel under ambient conditions as described above is shown to provide a surfactantless method to synthesize elemental nanowires that allow control over composition, crystallinity, and spatial dimensions. The elemental nanowires display superior electrocatalytic performance as oxygen reduction catalysts as compared with commercial nanoparticles.

While the invention has been shown and described with reference to certain embodiments of the present invention thereof, it will be understood by those skilled in the art that various changes in form and details may be made therein without departing from the spirit and scope of the present invention as defined by the appended claims and equivalents thereof.

What is claimed is:

1. A nanowire synthesis method comprising:
adding a first solution and a second solution into a vessel containing a porous template with the first solution added on one side of the porous template and the second solution added on another side of the porous template,
wherein the first solution contains a metal reagent comprising at least one of a transition metal, an actinide metal and a lanthanide metal, and
wherein the second solution contains a reducing agent.

2. The method of claim 1, wherein the synthesized nanowire consists of a single transition metal.

3. The method of claim 1, wherein the nanowire and surface thereof are substantially free of organic contaminants.

4. The method of claim 1, wherein the nanowire and surface thereof are substantially free of impurities.

5. The method of claim 1, wherein the first solution and the second solution are provided in a solvent comprising at least one of water and an alcohol, and mixtures thereof.

6. The method of claim 5, wherein the nanowire is synthesized with the solvent in a liquid state.

7. The method of claim 1, wherein the reducing agent comprises at least one of metal borohydrides, sodium cyanoborohydride, citric acid, citrate anion, ascorbic acid, ascorbate anion, formic acid, formate anion, oxalic acid, oxalate anion, lithium aluminum hydride, diborane, alpine borane, hydrogen gas, hydrazine, and 2-mercaptoethanol.

8. The method of claim 1, wherein the reducing agent comprises metals that include Na, Li, K, Rb, Cs, Ca, Mg, Al, and Zn.

9. The method of claim 1, wherein reduction of the metal reagent of the first solution occurs within a pore of the porous template.

10. The method of claim 9, wherein dimensions of the nanowire are defined by respective dimensions of the pore.

11. The method of claim 1, wherein the metal reagent comprises a metal salt comprising a metal cation of the transition metal, actinide metal or the lanthanide metal of the metal reagent, with a corresponding anion including at least one of halides, oxides, acetates, acetyl-acetates, nitrates, phosphates, sulfates, sulfides, citrates, hydroxides, amine halides, amine hydroxides, hydrogen halides, alkali halides, ethylenediamine halides, hydrogen hydroxides, cyanides and carbonates.

12. The method of claim 1, wherein a length of the nanowire is determined by a concentration of the reducing agent in the second solution.

13. The method of claim 1, wherein a length of the nanowire is determined by a concentration of the metal reagent in the first solution.

14. The method of claim 1, wherein a length of the nanowire is determined by reaction time.

15. An elemental nanowire formed by adding a first solution and a second solution to a vessel containing a porous template,
wherein the first solution is added on one side of the porous template and the second solution is added on another side of the porous template,
wherein the first solution contains a metal reagent comprising at least one of a transition metal, an actinide metal and a lanthanide metal, and
wherein the second solution contains a reducing agent.
